(19) United States
(12) Patent Application Publication
(10) Pub. No.: US 2018/0260064 A1
(43) Pub. Date: Sep. 13, 2018

(54) WEARABLE DEVICE AND CONTROL METHOD THEREFOR

(71) Applicant: LG ELECTRONICS INC., Seoul (KR)

(72) Inventors: Ingi CHAE, Seoul (KR); Euna JO, Seoul (KR); Yoonsoo KIM, Seoul (KR)

(73) Assignee: LG ELECTRONICS INC., Seoul (KR)

(21) Appl. No.: 15/756,462

(22) PCT Filed: Nov. 16, 2015
(86) PCT No.: PCT/KR2015/012268

§ 371 Date: Feb. 28, 2018

(30) Foreign Application Priority Data
Sep. 2, 2015 (KR) 10-2015-0124452

(51) Int. Cl. G06F 3/041; G06F 1/16; G06F 3/01; G04G 21/08

(52) U.S. Cl. CPC G06F 3/0414; G04G 21/08; G06F 3/011; G06F 1/163

(57) ABSTRACT

The present invention relates to a wearable device and a control method therefore, the device comprising: a wearable device body; at least one band coupled to the body, and formed so as to wrap around the wrist of a user wearing the wearable device; and a control unit provided in the body, and controlling at least one function executable in the wearable device on the basis of the user's input of pulling or pushing the at least one band and the user's inputs of pushing the body in a specific direction.

### TECHNICAL FIELD

The present invention relates to a wearable device and a control method thereof.

### BACKGROUND ART

A wearable device includes all kinds of electronic devices that a user can wear on the body or clothes. Such wearable device may be, for example, a smart watch, a wearable computer, a google glass, a Bluetooth headset, a smart wear, or the like.

Meanwhile, functions of the wearable devices are diversified due to technological advances. Examples of such functions include data and voice communications, capturing images and video via a camera, recording audio, playing music files via a speaker system, and displaying images and video on a display unit. In addition, in recent times, the wearable device may be provided with an electronic game play function or a multimedia player function. Specifically, the recent wearable devices may receive broadcast and multicast signals providing visual contents such as videos or television programs.

On the other hand, since a wearable device is manufactured in a form wearable on the wearer's body or clothing as described above, its size is generally limited. Accordingly, the present wearable device allows a user's input to be received in a format of a soft key displayed on a display unit, thereby efficiently receiving a user's input for controlling the various functions. However, in such a way, since it is impossible to provide a display unit having a screen width of a certain size or more on the basis of the characteristics of the wearable device, there a limitation in displaying keys for controlling various functions, and when displaying a large number of keys on a limited display portion, there is a problem that a user may be confused or may cause malfunction.

Accordingly, a method for efficiently and easily controlling functions provided in the wearable device is being actively researched.

### DISCLOSURE OF THE INVENTION

It is an object of the present invention to solve the above-mentioned problems and other problems, and it is an object of the present invention to provide a wearable device and a control method thereof that allow a user to more easily and conveniently select and control various functions.

Another object of the present invention is to provide a wearable device and a control method thereof that allow a user to select and control the provided functions of the wearable device without using the display unit of the wearable device.

According to an aspect of the present invention, there is provided a wearable device including: a main body; at least one band coupled to the main body and configured to wrap a wrist of a user wearing the wearable device; and a controller provided in the main body and configured to control at least one function executable in the wearable device on the basis of an input of a user pulling or pushing the at least one band and inputs of a user pushing the main body in a specific direction.

In an embodiment, the at least one band may be divided into a first band and a second band according to a position coupled to the main body, wherein the controller may control a function executed in the wearable device differently on the basis of inputs of a user pulling or pushing any one of the first band and the second band, an input of a user pulling both the first band and the second band, an input of a user pushing the main body in a first direction in which the first band is coupled to the main body, an input of a user pushing the main body in a second direction in which the second band is coupled to the main body, and an input of a user lifting the main body.

In an embodiment, when the wearable device is worn, the controller may sense that there is an input of a user lifting the main body on the basis of a detection result of a touch sensor formed on at least a portion of one surface of the main body contracting a user's body

In an embodiment, when both an input of a user pulling the first band and an input of a user pulling the second band are sensed, the controller may identify whether it is an input of a user pulling either the first band or the second band or an input of a user pulling both the first band and the second band on the basis of intensities of a force pulling the first band and a force pulling the second band.

In an embodiment, when an intensity difference of a force pulling the first band and a force pulling the second band is within a predetermined level, the controller may sense that there is an input of a user pulling both the first band and the second band, and when an intensity difference of a force pulling the first band and a force pulling the second band exceeds a predetermined level, the controller may sense that there is only an input of a user pulling one band that is pulled harder.

In an embodiment, on the basis of a change in pressure sensed in a pressure sensor formed in each portion of the main body to which the first band and the second band are coupled, the controller may sense an input of a user pulling the first band or the second band and measures intensities of a force pulling the first band and a force pulling the second band.

In an embodiment, when a position movement of the main body is sensed by a force applied in the first direction or the second direction, the controller may sense an input of a user pushing the main body in the first direction or the second direction on the basis of the sensed position movement of the main body.

In an embodiment, when the main body is lifted by a force applied to the main body in a vertical direction, the controller may sense an input of a user lifting the main body on the basis of a position movement of the main body.

In an embodiment, when a faster where the first band and the second band are coupled to each other in order to wrap a user's wrist is pulled in a direction opposite to a direction in which the main body is positioned, the controller may sense that there is an input of a user pulling the first and second bands at the same time.

In an embodiment, when at least one of the first band and the second band is pushed or pulled with a predetermined intensity or more or is pushed or pulled for a predetermined time or more, the controller may sense that there is an input of a user corresponding thereto.

In an embodiment, the controller may switch an operation mode of the wearable device to a specific operation mode on the basis of an input of a user pushing or pulling the at least one band and any one of inputs of a user pushing the main body in a specific direction, wherein the specific operation mode may be an operation mode for performing functions corresponding to a sensed state of a user according to a result of sensing a body state of the user.

In an embodiment, functions included in the specific operation mode may be set to correspond to an input of a user pulling or pushing the at least one band and inputs of a user pushing the main body in a specific direction, wherein on the basis of any one of the inputs of the user, the controller may execute any one function of the functions included in the specific operation mode.

In an embodiment, on the basis of any one of the inputs of the user, when any one of the functions included in the specific operation mode is executed, the controller may display information corresponding to the executed function on a display unit provided on the main body, wherein the information corresponding to the executed function may display a graphic object corresponding to the executed function.

In an embodiment, the controller may display the information corresponding to the executed function on the display unit during a time that any one of the inputs of the user is sensed.

In an embodiment, on the basis of any one of the inputs of the user, when any one of the functions included in the specific operation mode is executed, the controller may re-execute the any one executed function on the basis of the time that any one of the inputs of the user is sensed.

In an embodiment, on the basis of an input of a user pulling or pushing the at least one band and a force in a specific direction applied to the main body, the controller may switch an operation mode of the wearable device to a specific operation mode, wherein the specific operation mode may be an operation mode corresponding to a peripheral device sensed around the wearable device and connectable to the wearable device according to a result of sensing a surrounding situation of the wearable device.

In an embodiment, the peripheral device may be a vehicle on which a user wearing the wearable device is aboard and the specific operation mode may be an operation mode for performing functions related to a control of the vehicle.

In an embodiment, on the basis of an input pulling the first band, an input of a user pulling the second band, an input pushing the first band, an input of a user pushing the second band, or an input of a user pushing the main body in the first direction or the second direction, the controller may adjust a brightness or a volume of a display unit provided in the main body.

In an embodiment, on the basis of an input pulling the first band, an input of a user pulling the second band, an input pushing the first band, the controller may connect a call according to an incoming call or end a connected call.

According to an aspect of the present invention, there is provided a control method of a wearable device including a plurality of bands provided to wrap a wrist of a user, the method including: switching to a specific operation mode according to a result of sensing a body state of a user or a surrounding situation of the wearable device; sensing any one of inputs of a user pulling or pushing the plurality of bands and inputs of a user pushing a main body of the wearable device in a specific direction; and controlling at least one function executable in the wearable device on the basis of the sensed input of the user.

### Advantageous Effects

Effects of the wearable device and its control method according to the present invention will be described as follows.

According to at least one of the embodiments of the present invention, the present invention is advantageous in that a user may easily and quickly control a wearable device by allowing a user to perform or control a desired function simply by pushing or pulling a band or a main body provided in the wearable device.

Further, on the basis of the attractive force or the repulsive force applied to the wearable device body or the band, by allowing the specific function corresponding thereto to be performed or controlled, there is an advantage that the user may execute and control a desired function without applying a touch input to the display unit.

Further, the present invention senses a surrounding situation and switches to an operation state for performing a corresponding function, and on the basis of the force applied to the main body or the band of the wearable device, allows functions related to the current operation state to be performed. As a result, there is an advantage that a user may provide greater convenience in controlling the wearable device.

### BRIEF DESCRIPTION OF THE DRAWINGS

FIG. 1 is a block diagram showing a wearable device according to an embodiment of the present invention.

FIG. 2 is a perspective view showing an example of a watch type wearable device according to an embodiment of the present invention.

FIGS. 3 to 5B are conceptual diagrams showing examples in which a user's input is applied through a band in a wearable device according to an embodiment of the present invention.

FIGS. 6A to 6C are conceptual diagrams showing an example in which a user's input is applied on the basis of a force applied to a main body in a wearable device according to an embodiment of the present invention.

FIG. 7 is a flowchart showing an operation of performing a specific function on the basis of a force applied to a band or a main body in a wearable device according to an embodiment of the present invention.

FIG. 8 is a flowchart showing an operation process of performing any one function among functions corresponding to a band or a main body on the basis of a sensed force during the operation processes of FIG. 7.

FIG. 9 is a flowchart showing an operation process of performing a specific function on the basis of a force applied to a band during the operation processes of FIG. 8.

FIG. 10 is a flowchart showing an operation process of performing a specific function on the basis of a force applied to a main body during the operation processes of FIG. 8.

FIG. 11 is an exemplary view showing an example in which a wearable device according to an embodiment of the present invention controls the currently executing function on the basis of a force applied to a main body.

FIG. 12 is an exemplary view showing an example in which a wearable device according to an embodiment of the present invention controls the currently executing function on the basis of a force applied to a band.

FIG. 13 is an exemplary view showing an example in which a wearable device according to an embodiment of the present invention performs an operation accordingly when a user's input pulling a band is sensed while a music playback function is performed.

FIG. 14 is an exemplary view showing an example in which a wearable device according to an embodiment of the present invention performs an operation accordingly when a user's input pushing a band is sensed while a music playback function is performed.

FIG. 15 is an exemplary view showing an example in which a wearable device according to an embodiment of the present invention performs a specific operation on the basis of a force applied to the main body while performing a music playback function.

FIG. 16 is an exemplary view showing a state where a wearable device according to an embodiment of the present invention is connected to a vehicle.

### BEST MODE OF THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

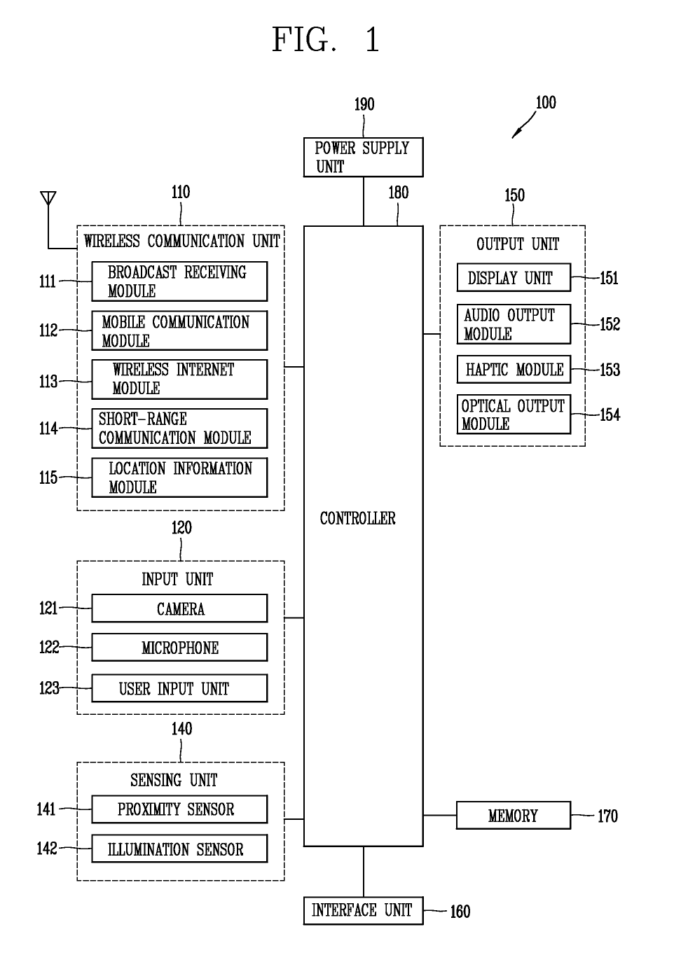

FIG. 1A is a block diagram of a wearable device in accordance with the present invention.

The wearable device 100 may be shown having components such as a wireless communication unit 110, an input unit 120, a sensing unit 140, an output unit 150, an interface unit 160, a memory 170, a controller 180, and a power supply unit 190. FIG. 1 shows the wearable device 100 having various components, but it may be understood that implementing all of the illustrated components is not a requirement. Greater or fewer components may alternatively be implemented.

In more detail, the wireless communication unit 110 may typically include one or more modules which permit communications such as wireless communications between the wearable device 100 and a wireless communication system, communications between the wearable device 100 and another wearable device, or communications between the wearable device 100 and an external server. Further, the wireless communication unit 110 may typically include one or more modules which connect the wearable device 100 to one or more networks.

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the wearable device 100, the surrounding environment of the wearable device 100, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The wearable device disclosed herein may be configured to utilize information obtained from one or more sensors, and combinations thereof.

The output unit 150 may typically be configured to output various types of information, such as audio, video, tactile output, and the like. The output unit 150 may be shown having at least one of a display unit 151, an audio output module 152, a haptic module 153, and an optical output module 154. The display unit 151 may have an inter-layered structure or an integrated structure with a touch sensor in order to implement a touch screen. The touch screen may function as the user input unit 123 which provides an input interface between the wearable device 100 and the user and simultaneously provide an output interface between the wearable device 100 and a user.

The interface unit 160 serves as an interface with various types of external devices that are coupled to the wearable device 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the wearable device 100 may perform assorted control functions associated with a connected external device, in response to the external device being connected to the interface unit 160.

The memory 170 is typically implemented to store data to support various functions or features of the wearable device 100. For instance, the memory 170 may be configured to store application programs executed in the wearable device 100, data or instructions for operations of the wearable device 100, and the like. Some of these application programs may be downloaded from an external server via wireless communication. Other application programs may be installed within the wearable device 100 at the time of manufacturing or shipping, which is typically the case for basic functions of the wearable device 100 (for example, receiving a call, placing a call, receiving a message, sending a message, and the like). Application programs may be stored in the memory 170, installed in the wearable device 100, and executed by the controller 180 to perform an operation (or function) for the wearable device 100.

The controller 180 typically functions to control an overall operation of the wearable device 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 1A, to execute an application program that have been stored in the memory 170. In addition, the controller 180 may control a combination of at least two of those components included in the wearable device 100 to activate the application program.

The power supply unit 190 may be configured to receive external power or provide internal power in order to supply appropriate power required for operating elements and components included in the wearable device 100, under the control of the controller 180. The power supply unit 190 may include a battery, and the battery may be configured as an embedded battery or a detachable battery.

At least part of the components may cooperatively operate to implement an operation, a control or a control method of a wearable device according to various embodiments disclosed herein. Also, the operation, the control or the control method of the wearable device may be implemented on the wearable device by an activation of at least one application program stored in the memory 170.

Hereinafter, description will be given in more detail of the aforementioned components with reference to FIG. 1A, prior to describing various embodiments implemented through the wearable device 100.

First, regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules may be utilized to facilitate simultaneous reception of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

The wireless signal may include various types of data depending on a voice call signal, a video call signal, or a text/multimedia message transmission/reception.

The wireless Internet module 113 refers to a module for wireless Internet access. This module may be internally or externally coupled to the wearable device 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A) and the like. The wireless Internet module 113 may transmit/receive data according to one or more of such wireless Internet technologies, and other Internet technologies as well.

When the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the wearable device 100 and a wireless communication system, communications between the wearable device 100 and another wearable device, or communications between the wearable device and a network where another wearable device (or an external server) is located, via wireless area networks. One example of the wireless area networks is a wireless personal area networks.

Here, another mobile terminal (which may be configured similarly to wearable device 100) may be a wearable device, for example, a smart watch, a smart glass or a head mounted display (HMD), which is able to exchange data with the wearable device 100 (or otherwise cooperate with the wearable device 100). The short-range communication module 114 may sense or recognize the wearable device, and permit communication between the wearable device and the wearable device 100.

In addition, when the sensed wearable device is a device which is authenticated to communicate with the wearable device 100, the controller 180, for example, may cause transmission of at least part of data processed in the wearable device 100 to the wearable device via the short-range communication module 114. Accordingly, the user of the wearable device 100 can use the data processed in the other wearable device through the wearable device 100 according to the embodiment of the present invention. For example, when a call is received in the device, the user may answer the call using the wearable device 100. Also, when a message is received in the device, the user may check the received message using the wearable device 100.

The location information module 115 is generally configured to detect, calculate, derive or otherwise identify a position (or current position) of the wearable device 100. As an example, the location information module 115 includes a Global Position System (GPS) module, a Wi-Fi module, or both. For example, when the wearable device uses a GPS module, a position of the wearable device may be acquired using a signal sent from a GPS satellite. As another example, when the wearable device 100 uses the Wi-Fi module, a position of the wearable device 100 may be acquired based on information related to a wireless access point (AP) which transmits or receives a wireless signal to or from the Wi-Fi module. If desired, the location information module 115 may alternatively or additionally function with any of the other modules of the wireless communication unit 110 to obtain data related to the position of the wearable device 100. The location information module 115 is a module used for acquiring the position (or the current position) of the wearable device 100, and may not be limited to a module for directly calculating or acquiring the position of the wearable device 100.

Next, the input unit 120 is configured to permit various types of inputs to the wearable device 100. Examples of such inputs include image information (or signal), audio information (or signal), data or various information input by a user, and may be provided with one or a plurality of cameras 121. Such cameras 121 may process image frames of still pictures or video obtained by image sensors in a video or image capture mode. The processed image frames can be displayed on the display unit 151 or stored in memory 170. Meanwhile, the cameras 121 may be arranged in a matrix configuration to permit a plurality of images having various angles or focal points to be input to the wearable device 100, and a plurality of image information having various angles or focal points may be input in the wearable device 100 through the cameras 121 having the matrix configuration. Also, the cameras 121 may be located in a stereoscopic arrangement to acquire left and right images for implementing a stereoscopic image.

The microphone 122 processes an external audio signal into electric audio (sound) data. The processed audio data may be processed in various manners according to a function being executed in the wearable device 100. If desired, the microphone 122 may include assorted noise removing algorithms to remove unwanted noise generated in the course of receiving the external audio signal.

The user input unit 123 is a component that permits input by a user. Such user input may enable the controller 180 to control an operation of the wearable device 100. The user input unit 123 may include one or more of a mechanical input element (for example, a mechanical key, a button located on a front and/or rear surface or a side surface of the wearable device 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the wearable device 100, surrounding environment information of the wearable device 100, user information, or the like, and generates a corresponding sensing signal. The controller 180 generally cooperates with the sending unit 140 to control operations of the wearable device 100 or execute data processing, a function or an operation associated with an application program installed in the wearable device 100 based on the sensing signal. The sensing unit 140 may be implemented using any of a variety of sensors, some of which will now be described in more detail.

The proximity sensor 141 refers to a sensor to sense presence or absence of an object approaching a surface, or an object located near a surface, by using an electromagnetic field, infrared rays, or the like without a mechanical contact. The proximity sensor 141 may be arranged at an inner region of the wearable device 100 covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the wearable device 100 to execute different operations or process different data (or information) according to whether a touch with respect to the same point on the touch screen is either a proximity touch or a contact touch.

A touch sensor senses a touch (or a touch input) applied to the touch screen (or the display unit 151) using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

Meanwhile, the controller 180 may execute the same or different controls according to a type of touch object that touches the touch screen or a touch key provided in addition to the touch screen. Whether to execute the same or different control according to the object which provides a touch input may be decided based on a current operating state of the wearable device 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize location information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121, which has been depicted as a component of the input unit 120, typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors (TRs) at rows and columns to scan content received at the photo sensor using an electrical signal which changes according to the quantity of applied light. Namely, the photo sensor may calculate the coordinates of the physical object according to variation of light to thus obtain location information of the physical object.

The display unit 151 is generally configured to output information processed in the wearable device 100. For example, the display unit 151 may display execution screen information of an application program executing at the wearable device 100 or user interface (UI) and graphic user interface (GUI) information in response to the execution screen information.

Also, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 may receive audio data from the wireless communication unit 110 or output audio data stored in the memory 170 during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the wearable device 100. The audio output module 152 may also be implemented as a receiver, a speaker, a buzzer, or the like.

A haptic module 153 can be configured to generate various tactile effects that a user feels, perceives, or otherwise experiences. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the wearable device 100.

An optical output module 154 can output a signal for indicating an event generation using light of a light source. Examples of events generated in the wearable device 100 may include message reception, call signal reception, a missed call, an alarm, a schedule notice, an email reception, information reception through an application, and the like.

A signal output by the optical output module 154 may be implemented in such a manner that the wearable device 100 emits monochromatic light or light with a plurality of colors to a front or rear surface. The signal output may be terminated as the mobile terminal senses that a user has checked the generated event, for example.

The interface unit 160 serves as an interface for every external device to be connected with the wearable device 100. For example, the interface unit 160 can receive data transmitted from an external device, receive power to transfer to elements and components within the wearable device 100, or transmit internal data of the wearable device 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the wearable device 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the wearable device 100 is connected with an external cradle, the interface unit 160 may serve as a passage to allow power from the cradle to be supplied to the wearable device 100 or may serve as a passage to allow various command signals input by the user from the cradle to be transferred to the wearable device therethrough. Various command signals or power input from the cradle may operate as signals for recognizing that the wearable device 100 is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a flash memory type, a hard disk type, a solid state disk (SSD) type, a silicon disk drive (SDD) type, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The wearable device 100 may also be operated in relation to a network storage device that performs the storage function of the memory 170 over a network, such as the Internet.

The controller 180 may typically control operations relating to application programs and the general operations of the wearable device 100. For example, the controller 180 may set or release a lock state for restricting a user from inputting a control command with respect to applications when a status of the wearable device 100 meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 may control one or a combination of those components in order to implement various exemplary embodiments disclosed herein on the wearable device 100 according to the present invention.

The power supply unit 190 receives external power or provides internal power and supply the appropriate power required for operating respective elements and components included in the wearable device 100 under the control of the controller 180. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

These wearable devices include smart watches, smart glasses, head mounted displays (HMDs), and the like. Hereinafter, examples of the wearable device 100 will be described.

For example, the mobile terminal may exchange data (or interlock with) the wearable device 100. The short-range communication module 114 may sense or recognize the mobile terminal, which can perform communication with the wearable device 100, around the wearable device 100. In addition, when the sensed mobile terminal is a device which is authenticated to communicate with the wearable device 100, the controller 180, for example, may receive at least part of data processed in the mobile terminal into the wearable device 100 via the short-range communication module 114. Hence, a user can use the data processed in the mobile terminal on the wearable device 100. For example, when a call is received in the mobile terminal, the user may answer the call using the wearable device 100. Also, when a message is received in the device, the user may check the received message using the wearable device 100.

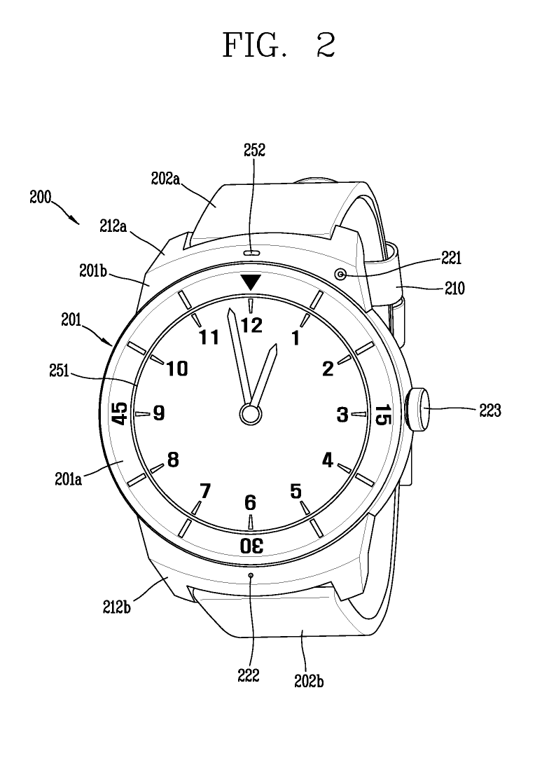

FIG. 2 is a perspective view illustrating an example of a watch-type wearable device 100 according to one embodiment of the present invention.

Referring to FIG. 2, a watch-type wearable device, namely, a smart watch includes a main body 201 having a display unit 251, and a band 202 connected to the main body 201 and configured to be worn on a wrist. In general, the watch type wearable device may include features of the wearable device 100 of FIG. 1 or similar features.

The main body 201 includes a case which defines appearance. As illustrated, the case may include a first case 201a and a second case 201b cooperatively defining an inner space for accommodating various electronic components. However, the present invention is not limited to this, and one case may be configured to define the inner space, thereby implementing a wearable device 200 with a uni-body.

The watch-type wearable device 200 may perform wireless communication, and an antenna for the wireless communication can be installed in the main body 201. On the other hand, the antenna may extend its function using the case. For example, a case including a conductive material may be electrically connected to the antenna to extend a ground area or a radiation area.

The display unit 251 may be disposed on a front surface of the main body 201 to output information, and a touch sensor may be provided on the display unit 251 to implement a touch screen. As illustrated, a window 251a of the display unit 251 may be mounted on a first case 201a to form the front surface of the terminal body together with the first case 201a.

The main body 201 may include an audio output unit 252, a camera 221, a microphone 222, a user input unit 223, and the like. When the display unit 251 is implemented as the touch screen, the display unit 351 may function as a user input unit 223, so that the main body 201 may not have a separate key.

On the other hand, the band 202a, 202b may be provided with a first band 202a and a second band 202b depending on to which one of band coupling portions 212a and 212b of the coupled main body 201 the band is coupled. The first and second bands 212a and 212b may be worn on the wrist so as to surround the wrist, and may be formed of a flexible material for easy wearing. For example, the first and second bands 202a and 202b may be made of leather, rubber, silicone, synthetic resin, or the like. The first and second bands 212a and 212b may be detachable from the main body 201, and may be configured to be replaceable with various types of bands according to the user's preference.

Meanwhile, the first and second bands 202a and 202b may be used to extend the performance of the antenna. For example, the first and second bands 202a and 202b may include a ground extending portion (not shown) electrically connected to the antenna to extend the ground region.

The first and second bands 202a and 202b may be provided with a fastener 210. The fastener 210 may be embodied by a buckle type, a snap-fit hook structure, a Velcro® type, or the like, and include a flexible section or material. The drawing illustrates an example that the fastener 201 is implemented in the form of a buckle.

Meanwhile, the sensing unit 140 of the wearable device 100 according to an embodiment of the present invention may sense a change in the pressure applied from the first band 202a or the second band 202b. For example, the sensing unit 140 may include pressure sensors in each of a first band coupling unit 212a coupled to the first band 202a and a second band coupling unit 212b coupled to the second band 202b. And, when the first band 202a or the second band 202b is pulled by the user, the force that the user pulls the first band 202a or the second band 202b, that is, the intensity of the pulling force, may be measured from the decrease amount in the generated pressure. And, on the other hand, when the first band 202a or the second band 202b is pushed by the user, the intensity of the force that the user pushes the first band 202a or the second band 202b may be measured from the increase amount in the generated pressure.

Herein, when a user applies a force to the first band 202a or the second band 202b in a direction opposite to the direction in which the main body 201 is located, the controller 180 may sense that there is an input of a user pulling the first band 202a or the second band 202b. On the other hand, when a user applies a force to the first band 202a or the second band 202b in a direction in which the main body 201 is located, the controller 180 may sense that there is an input of a user pushing the first band 202a or the second band 202b. That is, in the following description, it is assumed that ‘pulling’ the first band 202a or the second band 202b means applying the force to the first band 202a or the second band 202b in a direction opposite to the direction in which the main body 201 is located. In addition, it is assumed that “pushing” the first band 202a or the second band 202b means applying the force to the first band 202a or the second band 202b in a direction in which the main body 201 is located.

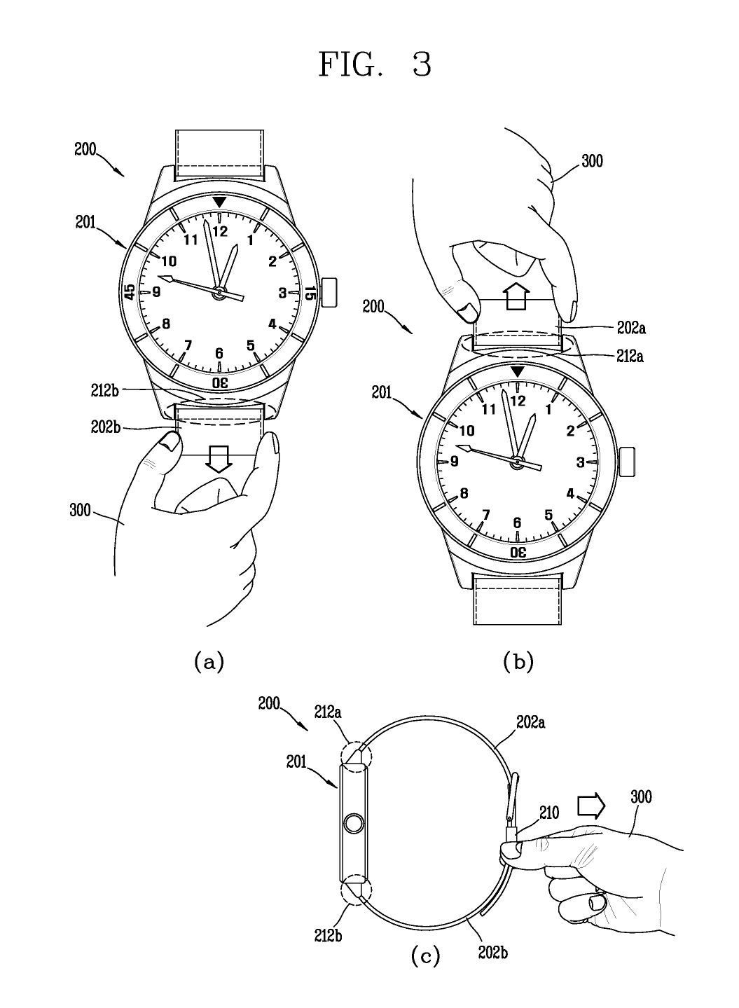

FIG. 3 is a conceptual diagram showing an example in which pulling occurs in the first band 202a and/or the second band 202b.

Referring to FIG. 3, when a user pulls the second band 202b as shown in FIG. 3(a), the second band coupling unit 212b of the main body 201 may sense this using a provided sensor (e.g., a pressure sensor). And, when a force pulling the second band 202b is sensed from a sensor of the second band coupling unit 212b, the controller 180 may determine that there is an input from the user corresponding to the pulling of the second band 202b.

Similarly, FIG. 3(b) shows an example in which the user pulls the first band 202a. That is, when the user grasps and pulls one point of the first band 202a as shown in FIG. 3(b), the first band coupling unit 212a may sense this using a provided sensor (e.g., a pressure sensor). And, when a force pulling the first band 202a is sensed from a sensor of the first band coupling unit 212a, the controller 180 may determine that there is an input from the user corresponding to the pulling of the first band 202a.

On the other hand, when the user pulls the coupled portion of the first band 202a and the second band 202b, the first band 202a and the second band 202b may be simultaneously pulled. That is, as shown in FIG. 3(c), when the user pulls the fastener 210 to which the first band 202a and the second band 202b are coupled, the first band 202a and the second band 202b may be pulled at the same time, and sensors included in the first band coupling unit 212a and the second band coupling unit 212b may sense forces due to this pulling. Accordingly, on the basis of the ‘pulling forces’ sensed by the sensors of the first band coupling unit 212a and the second band coupling unit 212b, the controller 180 may determine that there is a user's input corresponding to a case where the first band 202a and the second band 202b are pulled at the same time.

Meanwhile, when a force pulling the first band 202a and/or the second band 202b is sensed, on the basis of the intensity of the force pulling the bands 202a and 202b, the controller 180 may determine that the user is pulling any one of the bands 202a and 202b. For example, as the wearable device 100 is temporarily shifted in one direction due to the inertial influence by the movement of the user, a pulling force may be sensed at a specific band temporarily. And, there may be a case where the pulling force temporarily applied to such a specific band is erroneously sensed as the input of the user. To prevent this, when a pulling force is sensed from the first band 202a and/or the second band 202b, on the basis of whether the pulling force sensed by the bands 202a and 202b is greater than or equal to a predetermined level or is applied for a predetermined time or more, the controller 180 may determine that there is an input from the user corresponding to one of the bands 202a and 202b being pulled.

On the other hand, as shown in FIG. 3, when the user pulls one of the bands, since the first band 202a and the second band 202b are currently in a state of being coupled to each other, the band to which the user applies force, that is, the band that the user pulls, and the other band may be affected by the applied force. In this case, the sensing unit 140 of the wearable device 100 according to an embodiment of the present invention may measure the degree of the pulling of each of the bands 202a and 202b, and the controller 180 may determine that one of the bands is pulled by the user on the basis of the measurement result.

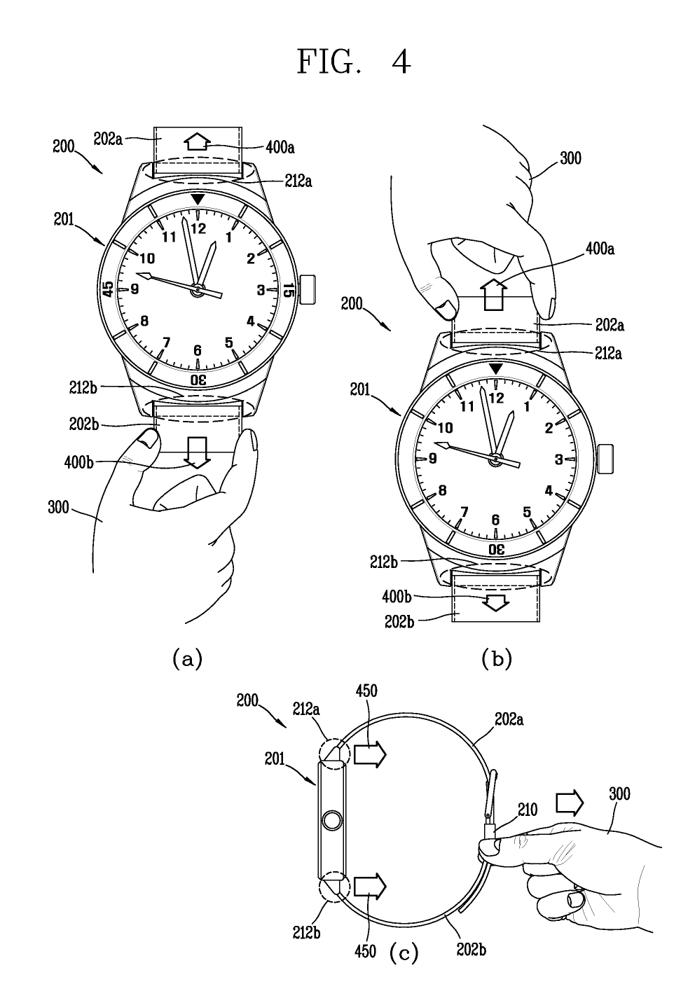

FIG. 4 is a conceptual diagram showing magnitudes of forces applied to the first band 202a and/or the second band 202b when a user pulls one of the bands as described above.

For example, referring to FIG. 4(a) showing an example in which the second band 202b is pulled, a force 400b due to pulling of the user may be applied to the second band 202b pulled by the user. And, when the second band 202b is pulled like this, the force 400b applied to the second band 202b may affect not only the second band 202b but also the first band 202a.

That is, as shown in FIG. 4(a), when the second band 202b is pulled along with the force 400b applied to the second band 202b, the force 400a pulling the first band 202a may be applied to the first band 202a. This is because the first band 202a and the second band 202b are coupled to each other through the fastener 210 as shown in FIGS. 2 and 4(a).

In this case, the sensors of the second band coupling unit 212b coupled to the second band 202b and the first band coupling unit 212a coupled to the first band 202a may sense a force (second force: 400b) pulling the second band 202b and a force (first force: 400a) pulling the first band 202a, respectively. Accordingly, on the basis of the sensed second force 400b and first force 400a, the controller 180 may determine which band among the bands 202a and 202b is pulled from the user.

For example, the controller 180 may compare the sensed forces with each other, and determine that the band where the intensity of the force is strongly sensed is a band pulled by the user. That is, as shown in FIG. 4(a), when the user pulls the second band 202b, the second force 400b sensed by the second band coupling unit 212b may be sensed more heavily than the first force 400a sensed by the first band coupling unit 212a. This is because the second force 400b is a force generated as the user directly pulls the second band 202b and the first force 400a is a force generated as the first band 202a coupled with the second band 202b is indirectly pulled by the pulled second band 202b when the second band 202b is pulled.

Accordingly, when the user pulls the second band 202b, the intensity of the second force 400b sensed by the second band coupling unit 212b may be greater than the first force 400a sensed by the first band coupling unit 212a. Accordingly, the controller 180 may determine that the second band 202b is pulled by the user according to a result of comparing intensities of the forces 400a and 400b.

Meanwhile, when the first band 202a is pulled, the pulling of the first band 202a may be sensed in this manner. That is, referring to FIG. 4(b) showing an example in which the first band 202a is pulled, a force 400a due to pulling of the user may be applied to the first band 202a pulled by the user. And, when the first band 202a is pulled like this, the force 400a applied to the first band 202a may affect not only the second band 202b but also the first band 202a.

However, in such a case, the first force 400a sensed by the first band coupling unit 212a is a force generated as the user directly pulls the second band 202b, and when the first band 202a is pulled, the second force 400b is a force generated as the second band 202b coupled with the first band 202a is indirectly pulled by the pulled first band 202a. Accordingly, the first force 400a sensed by the first band coupling unit 212a may be sensed more heavily than the second force 400b sensed by the second band coupling unit 212b. Accordingly, the controller 180 may determine that the first band 202a is pulled by the user according to a result of comparing intensities of the forces 400a and 400b.

Moreover, FIG. 4(c) shows an example of the forces 450 sensed by the first band coupling unit 212a and the second band coupling unit 212b when the user pulls the fastener 210. For example, as shown in FIG. 4(c), when the user pulls the fastener 210, which is a portion where the first band 202a and the second band 202b are coupled, the first band 202a and the second band 202b may be simultaneously pulled by a certain level of force. In this case, the first band coupling unit 212a and the second band coupling unit 212b may sense the forces 450 pulling the first band 202a and the second band 202b, respectively. In this case, the intensities of the forces 450 may be the same or similar to each other. Here, the fact that the intensities of the forces 450 are similar to each other may mean that the intensity difference of the forces 450 is less than a certain level.

Meanwhile, likewise, in the first band coupling unit 212a and the second band coupling unit 212b, when more than a certain level of the same or similar forces 450 pulling the first band 202a and the second band 202b are sensed simultaneously, the controller 180 may sense this as an input that is different from that one of the first band 202a or the second band 202b is pulled. That is, as shown in FIGS. 3 and 4, when the first band 202a and/or the second band 202b are pulled by the user, the controller 180 may sense this as an input of a user applied in three different cases (a case where only the first band 202a is pulled, a case where only the second band 202b is pulled, a case where both the first band 202a and the second band 202b are pulled). And, according to each case, it may be sensed that there are different user's inputs.

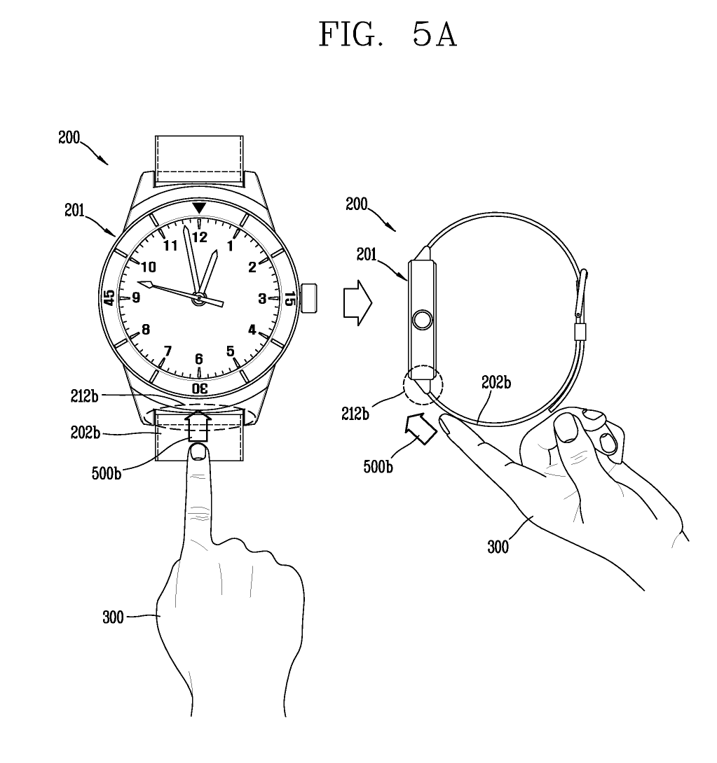

On the other hand, in FIGS. 3 and 4, although it is assumed that the band is pulled, on the contrary, when a user pushes a specific band, it is also possible to sense it. FIGS. 5A and 5B are conceptual diagrams showing an example of such a case.

In the above description, it is described as an example in which when the first band 202a and/or the second band 202b are pulled, the first band coupling unit 212a and/or the second band coupling unit 212b sense the force pulled by the first band 202a or the second band 202b and determine a user's input according thereto. However, conversely, the sensors provided in the first band coupling unit 212a and/or the second band coupling unit 212b may sense a force acting in a direction opposite to the pulling force, i.e., a pushing force.

For example, the sensors provided in the first band coupling unit 212a and/or the second band coupling unit 212b may sense a change in pressure, i.e., a decrease in pressure, which occurs as the first band 202a and/or the second band 202b are pulled, thereby sensing that the first band 202a or the second band 202b is being pulled. Then, similarly, the sensors provided in the first band coupling unit 212a and/or the second band coupling unit 212b may sense a change in pressure, i.e., an increase in pressure, caused by a force that the user pushes the first band 202a and/or the second band 202b toward the main body 201, respectively, thereby sensing that the band 202a or the second band 202b is being pushed by the user.

Accordingly, as shown in the first drawing of FIG. 5A, when the user pushes the second band 202b in the direction in which the main body 201 is located, the sensor of the second band coupling unit 212b coupled with the second band 202b may sense the pushing force 500b applied to the second band 202b. In this case, the pushing force 500b applied to the second band 202b may be applied along the direction in which the second band 202b is coupled to the second band coupling unit 212b, as shown in the second drawing of FIG. 5A. And, on the basis of the pushing force 500b sensed by the sensor of the second band coupling unit 212b, the controller 180 may determine that the user is pushing the second band 202b and sense this as a user's input.

On the other hand, as shown in the first drawing of FIG. 5B, when the user pushes the first band 202a in the direction in which the main body 201 is located, the sensor of the first band coupling unit 212a coupled with the first band 202a may sense the pushing force 500a applied to the first band 202a. In this case, the pushing force 500a applied to the first band 202a may be applied along the direction in which the first band 202a is coupled to the first band coupling unit 212a, as shown in the second drawing of FIG. 5B. And, on the basis of the pushing force 500a sensed by the sensor of the first band coupling unit 212a, the controller 180 may determine that the user is pushing the first band 202a and sense this as a user's input.

Meanwhile, when a force pushing the first band 202a and/or the second band 202b is sensed, on the basis of the intensity of the force pushing the bands 202a and 202b, the controller 180 may determine that the user is pushing any one of the bands 202a and 202b. For example, as the wearable device 100 is temporarily shifted in one direction due to the inertial influence by the movement of the user, a pushing force may be sensed at a specific band temporarily. And, there may be a case where the pushing force temporarily applied to such a specific band is erroneously sensed as the input of the user. To prevent this, when a pushing force is sensed from the first band 202a and/or the second band 202b, on the basis of whether the pushing force sensed by the bands 202a and 202b is greater than or equal to a predetermined level or is applied for a predetermined time or more, the controller 180 may determine that there is an input from the user corresponding to one of the bands 202a and 202b being pushed.

Meanwhile, in the first band coupling unit 212a or the second band coupling unit 212b, when a force pushing the first band 202a or the second band 202b is sensed, the controller 180 may sense this as different user's inputs.

Meanwhile, although not shown, it is apparent that the forces pushing the bands 202a and 202b may be applied at the same time as the pressing force is applied to the specific band as described above. For example, when the user pushes the bands 202a and 202b in the direction in which the main body 201 is located, it is apparent that the first band coupling unit 212a and the second band coupling unit 212b may simultaneously sense the pushing forces applied to the first band 202a and the second band 202b, respectively. And, when pushing forces simultaneously applied to the first band 202a and the second band 202b are sensed, the controller 180 may sense this as the user's input different from a case where a pushing force is applied to one of the first band 202a and the second band 202b.

Meanwhile, the present invention may sense a case where the first band 202a or the second band 202b is pulled or pushed and a case where a force in a specific direction is applied to the main body 201. For this, the sensing unit 140 of the wearable device 100 according to an embodiment of the present invention may use an acceleration sensor or the like. For example, when the position of the main body 201 is moved by a force in a specific direction applied to the main body 201, the controller 180 may sense the acceleration generated from the position movement of the main body 201. Then, from the sensed acceleration, the magnitude of the force applied to the main body 201 and the direction of the force may be sensed.

For example, as shown in FIG. 2, in the case of the wearable device 100 mounted on a user's cuff through the first band 202a and the second band 202b, the wearable device 100 shown in FIG. 2 in the direction in which the first band 202a or to the second band 202b is mounted is assumed. In a state that the user wears the wearable device, when a force is applied in the 12 o'clock direction (direction in which the first band 202a is coupled: first direction) or the 6 o'clock direction (direction in which the second band 202b is coupled: second direction) from the center of the display unit 251, the main body 201 may be moved in the first direction or the second direction by the applied force. In this case, the controller 180 may measure the direction of the force applied to the main body 201 and the magnitude of the force on the basis of the acceleration sensed by the acceleration sensor.

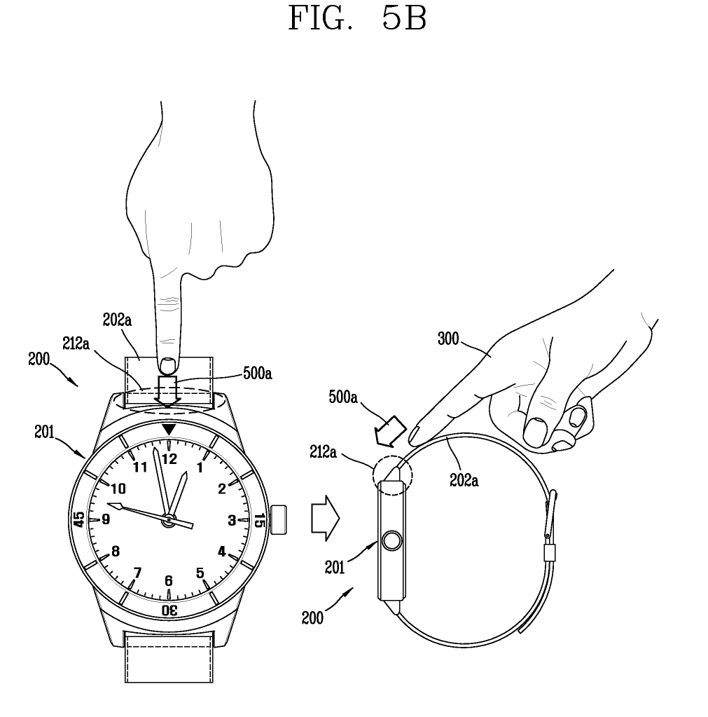

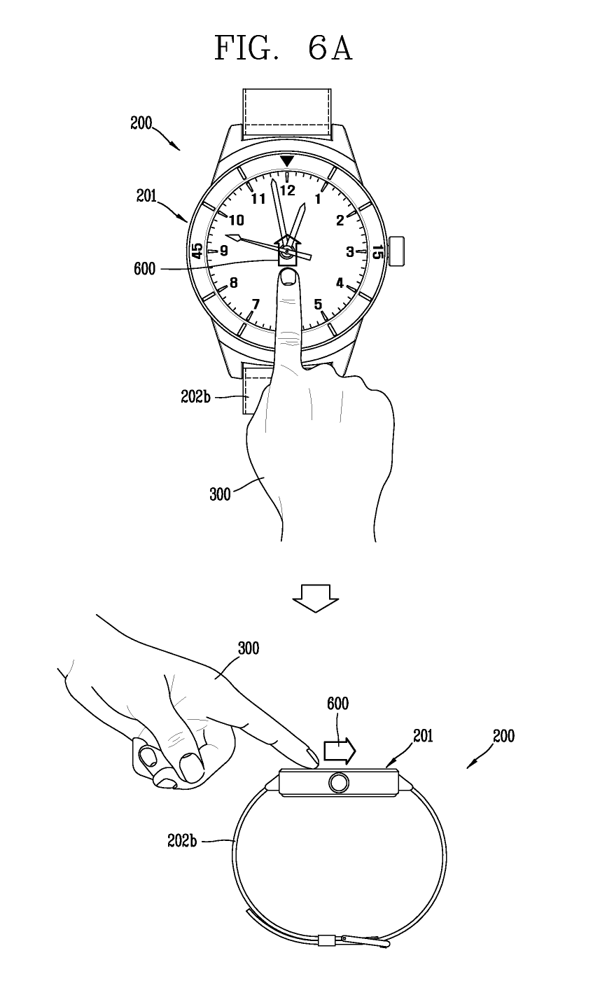

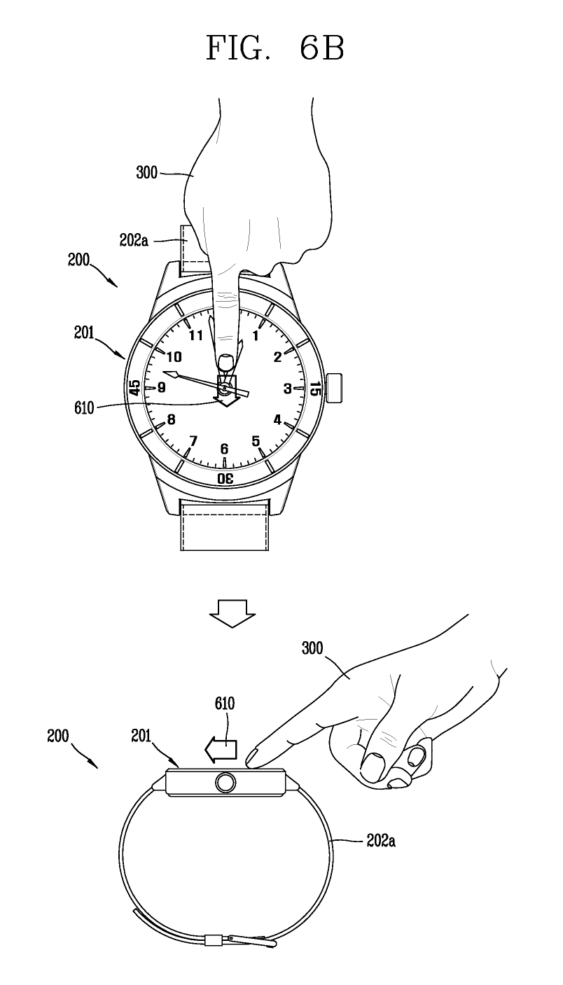

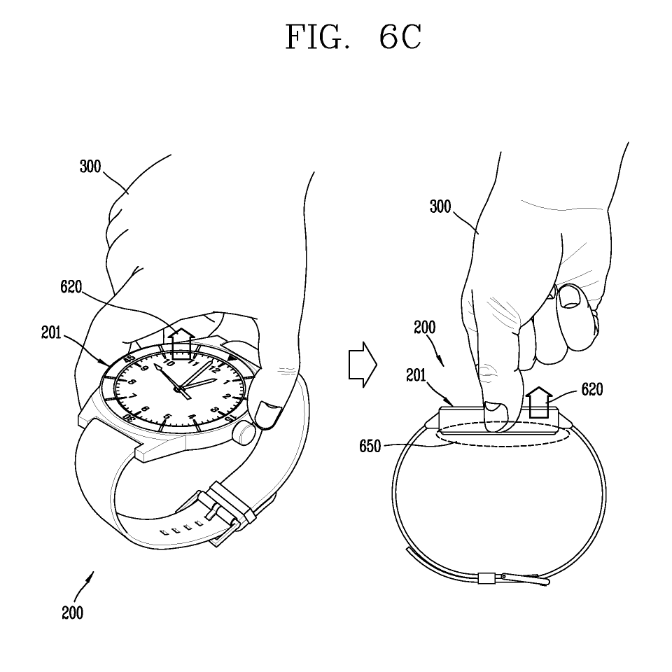

FIGS. 6A and 6B show an example of a case where a force is applied in the horizontal direction among cases where a force is applied to the main body 201 in such a way.

First, referring to the first drawing of FIG. 6A, the first drawing of FIG. 6A shows an example of a case where the user pushes the main body 201 in the 12 o'clock direction, that is, the first direction. In other words, as shown in the first drawing of FIG. 6A, when the user pushes the main body 201 in the first direction, a force 600 applied in the first direction may be applied to the main body 201. In this case, as shown in the second drawing of FIG. 6A, the force 600 applied in the first direction may be a force applied to the main body 201 in the horizontal direction, and the position of the main body 201 may be horizontally moved in the first direction in which the force 600 is applied by the force 600 in the first direction.

In this case, the controller 180 may sense the position movement of the main body 201 horizontally moved in the first direction. For example, the controller 180 may sense an acceleration according to the movement of the main body 201 by using an acceleration sensor or the like. Then, on the basis of the sensed acceleration, the force pushing the main body 201 in the first direction, that is, the direction in which the first band 202a is coupled, may be sensed.

Moreover, FIG. 6B shows an example in which a force pushing the main body 201 is applied in a different direction, that is, a direction in which the second band 202b is coupled to the main body 201.

First, as shown in the first drawing of FIG. 6B, when the user pushes the main body 201 in the direction in which the second band 202b is coupled to the main body, that is, in the second direction, a force 610 applied in the second direction may be applied to the main body 201. In this case, as shown in the second drawing of FIG. 6B, the force 610 applied in the second direction may be a force applied to the main body 201 in the horizontal direction, and the position of the main body 201 may be horizontally moved in the second direction in which the force 610 is applied by the force 610 in the second direction.

In this case, the controller 180 may sense the position movement of the main body 201 moved horizontally in the second direction by using an acceleration sensor or the like. Then, on the basis of the sensed acceleration, the force pushing the main body 201 in the second direction, that is, the direction in which the second band 202b is coupled, may be sensed.

Meanwhile, when the forces 600 and 610 pushing the main body 201 in different directions are sensed, the controller 180 may sense the input of the user according to the direction in which the forces 600 and 610 are applied. That is, the controller 180 may sense that different user's inputs are applied according to the forces in different directions applied to the main body 201.

Meanwhile, the sensing unit 140 may sense not only the horizontal force applied in the first direction or the second direction, but also the vertical force. For example, when the user lifts the main body 201 in contact with the skin of the user, the controller 180 may sense the position movement of the main body 201. And, the controller 180 may sense a force applied to the main body 201 according to the position movement of the main body 201, that is, the position movement in the vertical direction.

FIG. 6C is a conceptual diagram showing an example in which a force in the vertical direction is applied to the main body 201 as described above.

First, referring to the first drawing of FIG. 6C, the first drawing of FIG. 6C shows an example in which the main body 201 of the wearable device 100 according to an embodiment of the present invention is vertically lifted by the user. When the main body 201 is lifted as described above, the sensing unit 140 may sense the position movement of the main body 201, that is, the position movement in the vertical direction.

In this case, as shown in the second drawing of FIG. 6C, the force 620 applied in the vertical direction may be a force applied to the main body 201 in the vertical direction. Then, when the vertical force is applied to the main body 201, the controller 180 may sense that there is a user's input different from cases where a force is applied to the main body 201 in the horizontal direction.

On the other hand, as shown in the second drawing of FIG. 6C, when a force is applied in the vertical direction, the controller 180 may further use at least one sensor to distinguish this more clearly. In other words, as shown in the second drawing of FIG. 6C, when the main body 201 is lifted, by the first band 202a and the second band 202b coupled to the main body 201, a force pulling the first band 202a and the second band 202b above a certain level may be sensed by the sensors of the first band coupling unit 212a and the second band coupling unit 212b. In this case, in order to more clearly distinguish between the case where the first band 202a and the second band 202b are pulled at the same time and the case where the main body 201 is lifted, the controller 180 may further use at least one sensor.

For example, the controller 180 may further use a touch sensor 650 provided on a surface of the main body 201 that contacts the human body, that is, the cuff of the user. In this case, in the case where a force pulling the first band 202a and the second band 202b is sensed at a predetermined level or more, when the human body is in contact with the touch sensor 650, the controller 180 determines that a force applied to the first band 202a and the second band 202b is sensed as a result of simultaneous pulling of the first band 202a and the second band 202b by the user.

However, when the detection result by the touch sensor 650 indicates that the human body is not in contact, the controller 180 may determine that a force applied to the first band 202a and the second band 202b is sensed as a result of the user lifting the main body 201.

Accordingly, when the first band 202a and the second band 202b are simultaneously pulled, the controller 180 of the wearable device 100 according to an embodiment of the present invention may more accurately distinguish and recognize the force applied to the wearable device 100 depending on whether the main body 201 is in contact with the user or not.

In the above description, it is described that the forces applied to the main body 201 and the bands 202a and 202b coupled to the main body 201 are sensed and this is sensed as different user's inputs, respectively. And, on the basis of the different user's inputs inputted on the basis of the forces applied to the main body 201 and the bands 202a and 202b coupled to the main body 201, the controller 180 may allow the functions provided by the wearable device 100 to be controlled differently or operate in different operation modes.

For example, in an operation state that performs a specific function, when a user's input recognized according to the force applied to the bands 202a and 202b coupled to the main body 201 and the main body 201 is sensed, the controller 180 may change the operation mode to a specific operation mode accordingly. Or, on the basis of the input of the user recognized according to the force applied to the bands 202a and 202b coupled to the main body 201 and the main body 201, the controller 180 may allow at least one of the executable functions to be executed or the currently executed function to be controlled according to the current operation state.

For this, information on a specific operation mode corresponding to the input of the user recognized according to the forces applied to the main body 201 and the bands 202a and 202b coupled to the main body 201 may be stored in the memory 170 of the wearable device 100. Also, when the wearable device 100 operates in a specific operation mode, information on a specific function corresponding to a user's input recognized according to a force applied to the bands 202a and 202b coupled to the main body 201 and the main body 201, or information on a control command of a specific function corresponding to the input of the recognized user may be stored.

In the above description, provided are examples of the user input method of the wearable device 100 according to an embodiment of the present invention for sensing various forces applied to at least one band or main body and accordingly sensing a user's input differently.

Hereinafter, embodiments relating to a control method that is to be implemented for the wearable device 100 configured in such a manner are described with reference to the accompanying drawings. It is apparent to those skilled in the art that the present invention may be specified in a different specific form without departing from the scope and essential features of the present invention. Moreover, in the following description, it is assumed that the wearable device 100 is a smart watch for convenience. However, the present invention is not limited thereto.

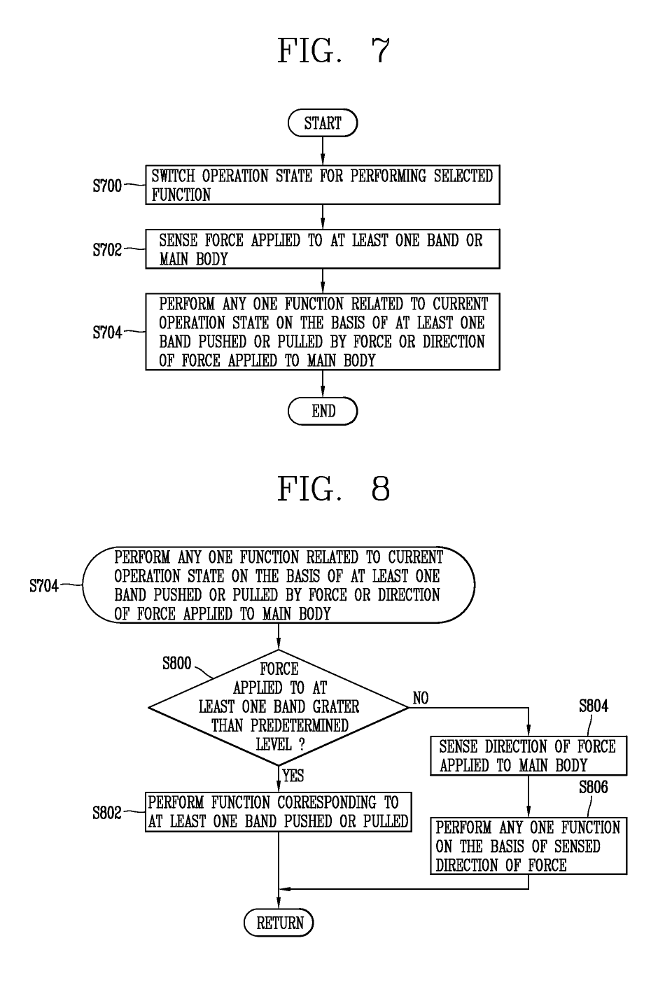

FIG. 7 is a flowchart showing an operation of performing a specific function on the basis of a force applied to a band or a main body in the wearable device 100 according to an embodiment of the present invention.

Referring to FIG. 7, when driving starts, the controller 180 of the wearable device 100 according to an embodiment of the present invention may switch to the operation state for performing the selected function (S700).

For example, when there is a user's selection, the controller 180 may switch to an operation mode for performing a specific function according to a user's selection, such as a key or a voice signal. Or, the controller 180 may switch directly to an operation mode for performing a specific function depending on the circumference of the wearable device 100 or the state of the user wearing the wearable device 100 through the sensing unit 140.

For example, when the user is running, on the basis of an increase in beat sensed by the body of the user, an increase in body temperature, or a shift in the position movement of the wearable device 100 that is regularly sensed to a certain level or more, the controller 180 may sense that the user is currently in a running state. In this case, in order to be set automatically when the user is exercising, the controller 180 may switch the current operation mode to an operation mode for performing a predetermined function from the user. For example, when the user is doing this exercise, the controller 180 may be operated in an operation mode for performing a function for checking the user's exercise situation on the basis of the state of the user. And, in this state, when the user applies an input for changing the operation mode, it is possible to switch the operation mode to another operation mode accordingly.

Or, when peripheral devices of the wearable device 100, for example, peripheral devices connectable to the wearable device 100, are sensed, the controller 180 may be switched to an operation mode for performing a specific function on the basis of the peripheral devices. For example, when a peripheral device such as a Bluetooth earphone is sensed, the controller 180 may switch to an operation mode in which a sound signal is outputted from the Bluetooth earphone.

Examples of such an operation mode include an operation mode for a music playback function or an operation mode for a voice communication function.

Meanwhile, in operation S700, when switched to the operation mode for performing a specific function, the controller 180 may sense a user's force applied to the wearable device 100 according to an embodiment of the present invention, that is, the main body 201 of the smartwatch 200, and at least one band coupled to the main body 201 (S702).

For example, the controller 180 may sense the force of the user pulling or pushing one of the first band 202a and the second band 202b in operation S702. Or, the controller 180 may sense the force of the user simultaneously pulling the first band 202a and the second band 202b. In addition, the controller 180 may sense the force of simultaneously pushing the first band 202a and the second band 202b.

In addition, in operation S702, the controller 180 may sense the force in the horizontal direction or the force in the vertical direction applied to the main body 201. Here, the force applied in the horizontal direction may have different directions, and when the horizontal force is applied to the main body 201 in such a way, the controller 180 may sense the direction in which the force is applied.

Meanwhile, when sensing a force applied to at least one of the main body 201 and the bands 202a and 202b in operation S702, the controller 180 may recognize the sensed force and perform any one of functions related to the current operation state on the basis of the sensed force (S704).

For example, the force sensed in operation S702 may be roughly divided into a force applied to the bands 202a and 202b and a force applied to the main body 201. Here, the force applied to the bands 202a and 202b may be divided into five types such as a force pulling only the first band 202a, a force pushing only the first band 202a, a force pulling only the second band 202b, a force pushing only the second band 202b, and a force pulling the first band 202a and the second band 202b simultaneously. And, a force simultaneously pushing the first band 202a and the second band 202b may be further added thereto.

Also, the force applied to the main body 201 may be roughly classified into three types such as a force applied in the first direction, a force applied in the second direction, and a force applied in the vertical direction.

In operation S704, the controller 180 may recognize the sensed forces by dividing them into the eight forces. Then, on the basis of the recognized forces, the user may sense that different inputs are applied. In other words, the controller 180 may recognize the forces applied to the bands 202a and 202b or the main body 201 in operation S704, and determine that the execution or control command of the specific function corresponding to the recognized force is selected by the user. Then, the wearable device 100 may be driven according to the execution or the control command of the specific function. Here, the execution of the specific function may include switching to another operation mode.

Accordingly, the present invention may change the operation mode of the wearable device 100 in an operation mode for performing various functions simply by pushing or pulling the bands 202a, 202b or the main body 201 even when the user does not input a key displayed through the display unit 251, and may enable various functions executable in the current operation state to be controlled.

Meanwhile, FIG. 8 is a flowchart showing in more detail an operation process of distinguishing and recognizing the forces applied to the bands 202a and 202b or the main body 201 and performing a function corresponding thereto, in the operation processes of FIG. 7.

Referring to FIG. 8, when the force applied to the bands 202a and 202b or to the main body 201 is sensed in operation S702 of FIG. 7, the controller 180 of the wearable device 100 according to an embodiment of the present invention may identify whether the force is applied to the bands 202a and 202b or to the main body 201. For example, the controller 180 may determine whether the force sensed in operation S702 is applied to the bands 202a and 202b or the main body 201 on the basis of the force applied to at least one of the bands 202a and 202b.

In other words, the controller 180 may determine whether a force applied to at least one of the bands 202a and 202b is equal to or greater than a preset level (S800). And, when at least one of the bands 202a and 202b senses a force of a predetermined level or more according to a determination result in operation S800, the controller 180 may determine that the force sensed in operation S702 of FIG. 7 is applied to one of the bands 202a and 202b.

This is because when the force is applied to the main body 201, the force sensed through the bands 202a and 202b is indirectly sensed according to a result of the force applied to the main body 201, and the intensity of the sensed force is weaker than a case where the force is directly transmitted through the bands 202a and 202b. Also, when the main body 201 is lifted, on the basis of the detection result of the touch sensor 650 formed on the bottom surface of the main body 201, that is, the portion directly contacting the human body, the controller 180 may determine whether the applied force is generated by the user simultaneously pulling the bands 202a and 202b or by lifting the main body 201.

Accordingly, when at least one of the bands 202a and 202b senses a force of a predetermined level or more according to a result of the determination in operation S800, the controller 180 may determine that at least one of the bands 202a, 202b is being pushed or pulled. And, the controller 180 may execute a specific function or control the currently executing function according to at least one band that is pushed or pulled (S802).

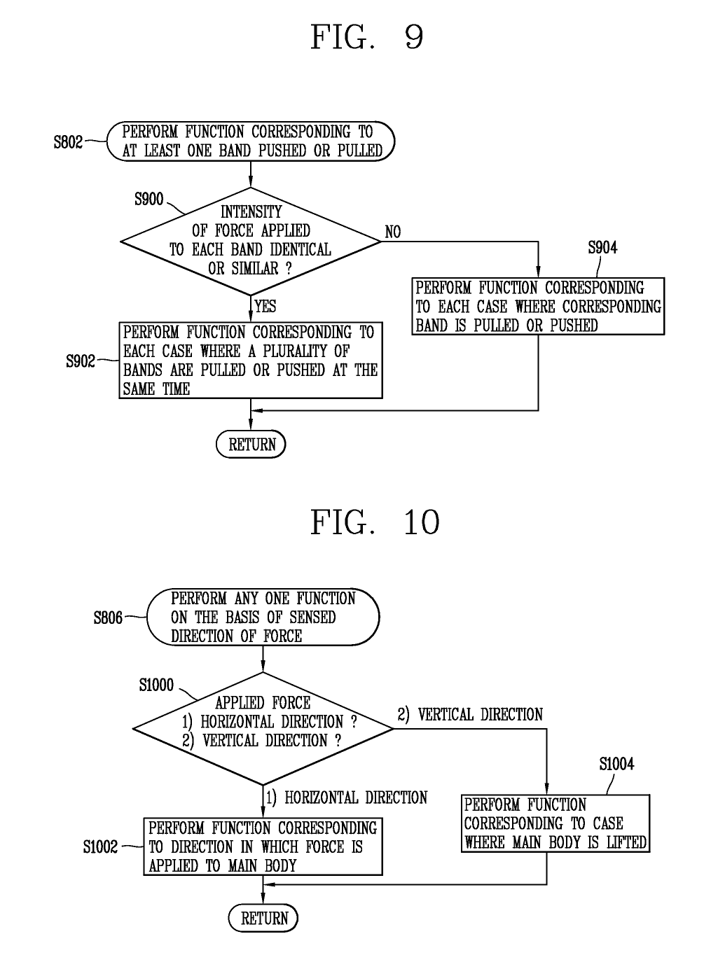

Hereinafter, when at least one of the bands 202a and 202b senses a force of a predetermined level or more in operation S800, the operation process of operation S800 for performing a specific function or controlling the currently executing function will be described in more detail with reference to FIG. 9.

Meanwhile, when at least one of the bands 202a and 202b is not sensed according to a result of the determination in operation S800, the controller 180 may determine that the currently applied force is the force applied to the main body 201. Then, the controller 180 may sense the direction of the force applied to the main body 201 (S804). For example, the controller 180 may sense the force in the horizontal direction or the force in the vertical direction applied to the main body 201 according to the sensed acceleration according to the movement of the main body 201. For example, the controller 180 may sense that a force is applied in a direction perpendicular to the main body according to the detection result of the acceleration sensor in operation S804 and whether the main body 201 is lifted accordingly. Here, the direction perpendicular to the main body 201 may be divided on the basis of the display unit 251 provided in the main body 201. For example, the force applied in the vertical direction may be a force applied in a direction in which the display unit 251 provided in the main body 201 faces, and the horizontal direction may be a force applied to the display unit 251 in a specific direction on a horizontal plane.

And, when the force in the horizontal direction or the force in the vertical direction applied to the main body 201 is sensed in operation S804, the controller 180 may perform a specific function corresponding to the direction of the sensed force or may control the currently executing function according to the direction in which the force is applied (S806). Hereinafter, the operation process of operation S806 for performing a specific function according to the direction of the force applied to the main body 201 or for controlling the currently executing function will be described in more detail with reference to FIG. 10.

Meanwhile, FIG. 9 is a flowchart showing an operation process of performing a specific function on the basis of a force applied to at least one of the bands 202a and 202b during the operation processes of FIG. 8.

Referring to FIG. 9, the controller 180 of the wearable device 100 according to an embodiment of the present invention may determine whether the forces (pushing and pulling forces) applied to the bands 202a and 202b coupled to the main body 201 of the wearable device 100 are the same or similar to each other (S900). Here, when the intensity difference of the force (pushing force or pulling force) applied to each of the bands 202a and 202b is equal to or less than a predetermined level, the controller 180 may determine that the forces applied to the bands 202a and 202b are similar to each other.

And, when the forces applied to the bands 202a and 202b are identical or similar to each other according to a determination result of operation S900, the controller 180 may determine that the bands 202a and 202b are simultaneously pushed or pulled. Accordingly, the controller 180 performs a specific function corresponding to the case where the bands 202a and 202b are pulled simultaneously, that is, the case where the bands 202a and 202b are pulled as shown in FIG. 3C, or control the currently executing function according to a specific control command (S902).

On the other hand, when the intensities of the forces applied to the bands 202a and 202b are not equal or similar to each other according to a determination result of operation S900, that is, when the intensity difference of the force applied to each of the bands 202a and 202b exceeds a predetermined level, the controller 180 may determine that only one of the bands 202a and 202b is pushed or pulled. Here, the controller 180 compares the forces applied to the bands 202a and 202b with each other to determine that any one band that the user pushes or pulls harder is selected by the user.

Accordingly, the controller 180 may execute a specific function corresponding to the force applied to any one of the selected bands, or may control the currently executing function according to a specific control command (S904). That is, when the user pushes or pulls the selected band, the controller 180 may allow different functions to be performed or the currently executing functions to be controlled differently.

In other words, when the intensity of the pulling or pushing force applied to the first band 202a is greater than the intensity of the pulling or pushing force applied to the second band 202b according to a determination result of operation S900, the controller 180 may determine that the user pushes or pulls the first band 202a. And, when the user pushes the first band 202a and pulls the first band 202a in operation S904, the controller 180 may perform different functions. Or, when the user pushes and pulls the first band 202a in operation S904, it is also possible to control the currently executing functions differently.

Meanwhile, FIG. 10 is a flowchart showing an operation process of performing a specific function on the basis of the direction of a force applied to the main body 201 during the operation processes of FIG. 8.

Referring to FIG. 8, when the direction of the force applied to the main body 201 is sensed in operation S804 of FIG. 8, the controller 180 of the wearable device 100 according to an embodiment of the present invention may perform an operation corresponding thereto. In other words, the controller 180 may determine whether the force applied to the main body 201 is in a horizontal direction or a vertical direction according to the detection result of operation S804 of FIG. 8 (S1000) and may execute a specific function or control the currently executing function according to a determination result of operation S1000.

That is, when the force applied to the main body 201 is applied in a specific direction on the horizontal plane of the display unit 251 of the main body 201 according to a determination result of operation S1000, the controller 180 may perform a specific function corresponding to a direction in which the force is applied to the main body 201 or may control the currently executing function according to a direction in which the force is applied.

For example, the force acting in the horizontal direction may be forces 600 and 610 acting in a first direction or a second direction, as shown in FIGS. 6a and 6b. In this case, the controller 180 may perform a different function for each of the force in the first direction and the force in the second direction, or may control the currently executing functions differently.

On the other hand, when a force applied to the main body 201 is applied in a direction perpendicular to the screen of the display unit 251 provided in the main body 201 according to a determination result in operation S1000, the controller 180 may perform a specific function, or may control the currently executing function according thereto. In other words, when the main body 201 is lifted as shown in FIG. 6C, the controller 180 may determine this as the force applied in the vertical direction of the main body 201 and may perform a specific function corresponding to the case where the main body 201 is lifted or may control the currently executing function. Herein, it is apparent that the controller 180 may sense that the main body 201 is lifted according to the detection result of a touch sensor formed on the bottom surface of the main body 201, that is, the surface contacting the human body.

Meanwhile, in the above description, the operation processes in which various functions are executed and the currently executing function is controlled on the basis of the force applied to at least one band or the main body in the wearable device 100 according to an embodiment of the present invention are described in detail with reference to the flowcharts.

In the above description, examples in which various functions are executed and the currently executing function is controlled on the basis of the force applied to at least one band or the main body in the wearable device 100 according to an embodiment of the present invention will be described in more detail with reference to the exemplary views.

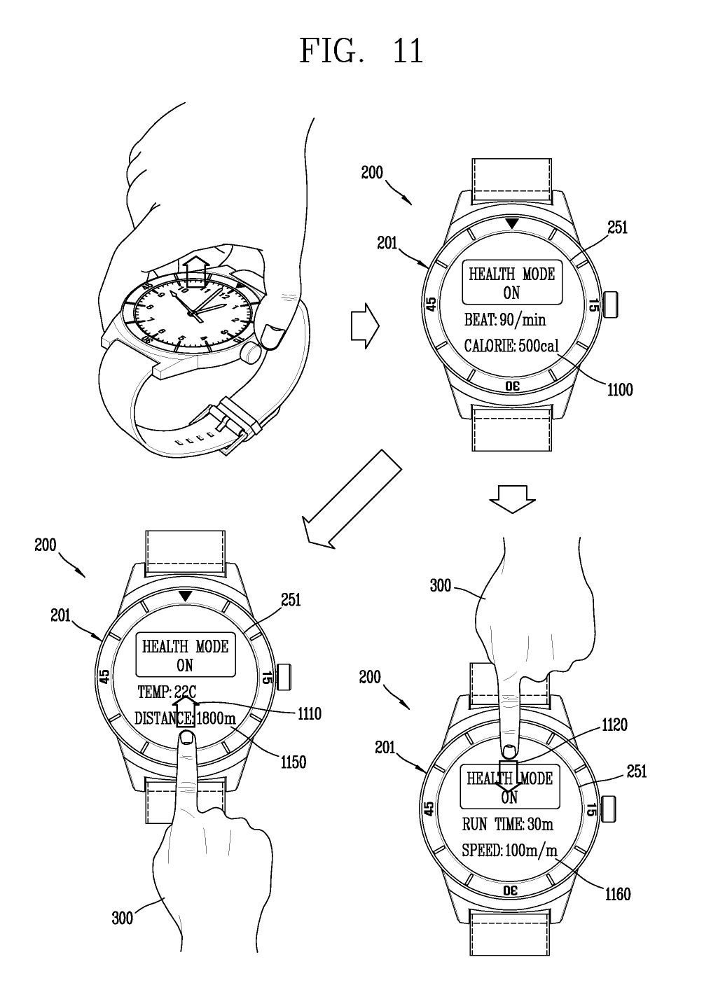

FIG. 11 is an exemplary view showing an example in which the wearable device 100 according to an embodiment of the present invention controls the currently executing function on the basis of the force applied to the main body 201.

As described above, when the bands 202a and 202b are pushed or pulled, or on the basis of the direction of the force applied to the main body 201, the controller 180 of the wearable device 100 according to an embodiment of the present invention may be switched to an operation mode for performing a specific function. In other words, as shown in the first drawing of FIG. 11, when the user lifts the main body 201 in the vertical direction, the controller 180 may switch the operation mode to the corresponding specific operation mode.

On the other hand, when the main body 201 is set to be switched to the ‘Health mode’ as the force is applied to the main body 201 in the vertical direction, the controller 180 may switch the operation mode of the wearable device 100 to the health mode. Here, ‘Health mode’ may be an operation mode for performing various functions related to the user's exercise state. Then, when the operation mode is switched to the health mode, the controller 180 may display on the display unit 251 information on the current operation mode, that is, the health mode, and information on various functions performable in the current operation mode. For example, the controller 180 may display on the display unit 251 information on a user's exercise state, for example, heart beat or calorie consumption. The second drawing of FIG. 11 shows an example of the wearable device 100 according to an embodiment of the present invention in which the operation mode is switched to the health mode as described above.

Meanwhile, in this state, the controller 180 may sense the force of the user pulling or pushing at least one of the bands 202a, 202b or the force applied to the main body 201 in a particular direction. Then, the controller 180 may determine that this is the user's input for controlling the currently executing operation mode.

For example, as shown in the third diagram of FIG. 11, when the user pushes the main body 201 in the second direction in which the second band 202b is coupled to the main body 201, the controller 180 may change the functions performable in the current operation mode on the basis of the force applied to the main body 201 in the second direction. That is, when the functions shown in the second drawing of FIG. 11 are functions for measuring heart beat and calorie consumption, the controller 180 may perform another function related to the current operation mode on the basis of the force applied to the main body 201 in the second direction. That is, for example, when the user is performing a running exercise, as shown in the third drawing of FIG. 11, the controller 180 may allow information related to the user's continuous running time and the user's running speed to be displayed on the display unit 251.

On the other hand, as shown in the fourth diagram of FIG. 11, when the user pushes the main body 201 in the first direction in which the first band 202a is coupled to the main body 201, the controller 180 may change the functions performable in the current operation mode on the basis of the force applied to the main body 201 in the first direction.

For example, in a state of displaying the heart beat or the calorie consumption shown in the second drawing of FIG. 11, on the basis of the force in the first direction applied to the main body 201, the controller 180 may allow the display unit 251 to display information on the current ambient temperature and the distance that the user is running. The fourth drawing of FIG. 11 shows this example.

Meanwhile, on the basis of the force of the user pulling or pushing the bands 202a and 202b coupled to the main body 201 as well as the force in the specific direction applied to the main body 201, the controller 180 may control not only the currently executing function but also execute specific other functions.

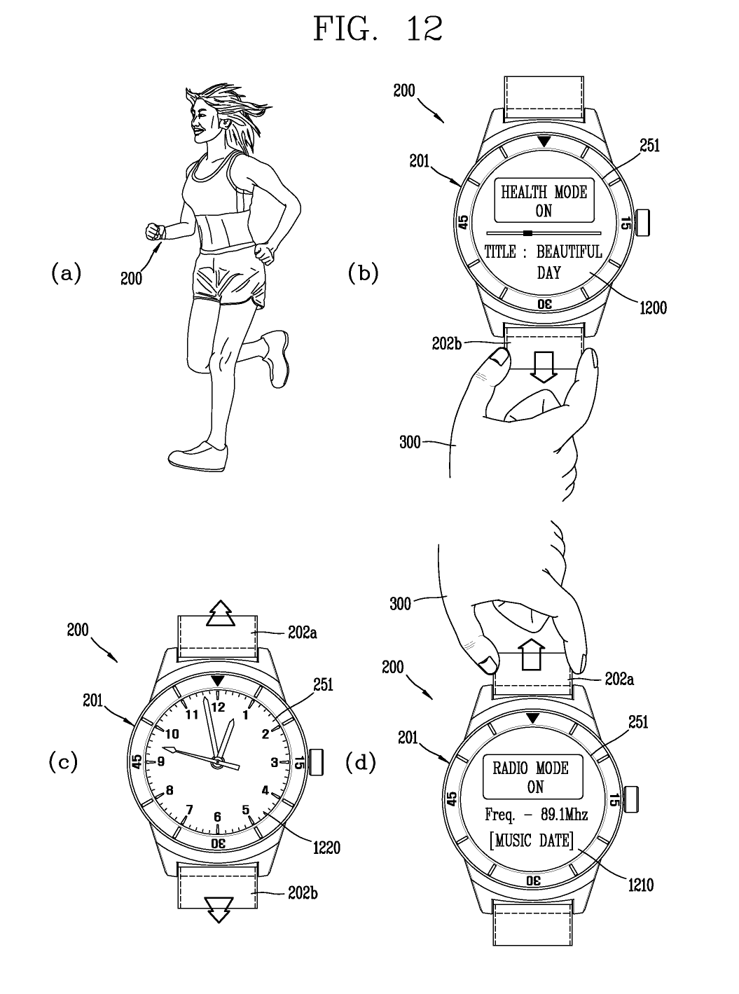

FIG. 12 is an exemplary view showing an example in which the wearable device 100 according to an embodiment of the present invention switches to the operation mode for executing a specific function on the basis of the force applied to the bands 202a and/or 202b.

First, as shown in FIG. 12(a), when the user wears the wearable device 100 according to an embodiment of the present invention and runs, the controller 180 may be switched to a health mode for sensing various physical conditions of a running user to provide various functions related to the exercise state. And, in this case, it may automatically switch to an operation mode for performing other functions on the basis of the force applied to the bands 202a and/or 202b.

For example, in a state where the health mode operates as described above, the controller 180 may sense a force pushing or pulling the band 202a and/or 202b. In other words, as shown in FIG. 12(b), when the user grasps and pulls one point of the second band 202b, the controller 180 may change the operation mode of the wearable device 100 to an operation mode for performing another function on the basis of the input of the user.

In other words, for example, when the operation mode corresponding to the pulling of the second band 202b is the operation mode for performing the music playback function, as shown in FIG. 12(b), in the case where the user grasps and pulls one point of the second band 202b, the controller 180 may change the operation mode to the music playback mode (Music mode) in which the music playback function is performed in response to the control signal. In this case, a screen 1200 related to the currently executing music playback function may be displayed on the display unit 251.

On the other hand, as shown in FIG. 12(c), when the user grasps and pulls one point of the first band 202a, the controller 180 may change the operation mode of the wearable device 100 to an operation mode for performing another function on the basis of the input of the user. Here, the operation mode corresponding to the input of the user pulling the first band 202a may be different from the operation mode corresponding to when the second band 202b is pulled. In other words, the operation mode corresponding to the input of the user pulling the first band 202a may be a radio mode in which a broadcast signal of a specific radio frequency channel is outputted. Accordingly, as shown in FIG. 12(c), when the user grasps and pulls one point of the first band 202a, the operation mode of the wearable device 100 may be changed to the radio mode in response thereto. In this case, a screen 1210 related to the currently executing radio function may be displayed on the display unit 251.

Meanwhile, in the above description, the cases where the operation mode corresponding to the input of the user pulling the first band 202a and the operation mode corresponding to the input of the user pulling the second band 202b are set in advance are described. Unlike this, it is apparent that the controller 180 may be set to correspond to a specific function according to a history of using the device 100.

For example, in the current operation state of the user, that is, in the state where the user is running, the controller 180 may generate history information of the operation modes of the wearable device 100 selected by the user. In this case, the history information may be information obtained by classifying the operation modes of the wearable device 100 according to the sensed state of the user. That is, when the sensed user's state is a specific state (for example, running, etc.), the controller 180 may collect information on the operation modes selected by the user.

On the other hand, the controller 180 may extract information on at least one operation mode in the order of being driving in the specific state, on the basis of the collected information on the operation modes. Then, on the basis of the extracted information, the controller 180 may determine an operation mode corresponding to an input of a user pulling the first band 202a and an operation mode corresponding to an input of a user pulling the second band 202b.

In other words, on the basis of the history information, the controller 180 may set the operation driven most when the user performs the running exercise to correspond to the operation mode corresponding to the input of the user pulling the first band 202a. And, the second most frequently driven operation mode may be set to correspond to the operation mode corresponding to the input of the user pulling the second band 202b. In this case, the operation mode of the wearable device 100 may be switched to the operation mode that is driven most when the user runs or the operation mode that is driven the second most frequently on the basis of the input of the user pulling the first band 202a or the second band 202b.

Meanwhile, unlike the case where either the first band 202a or the second band 202b is pulled, when the bands 202a and 202b are simultaneously pulled, the controller 180 may perform another function according to the input of the user. In other words, as shown in FIG. 12(d), when the first band 202a and the second band 202b are simultaneously pulled, the controller 180 may sense this as a user input to terminate the function currently being performed. Accordingly, when the first band 202a and the second band 202b are simultaneously pulled, as shown in FIG. 12(d), the controller 180 may terminate the operation state for performing a specific function and display the clock screen 1220 on the display unit 251.

Meanwhile, in the above description, when a force is applied to the main body 201 in a specific direction and at least one band 202a or 202b is pulled, an example is described in which an operation mode is switched or a specific function is executed. In addition, when the user pushes the at least one band 202a or 202b, it is apparent that other operation states or other functions may be executed accordingly.

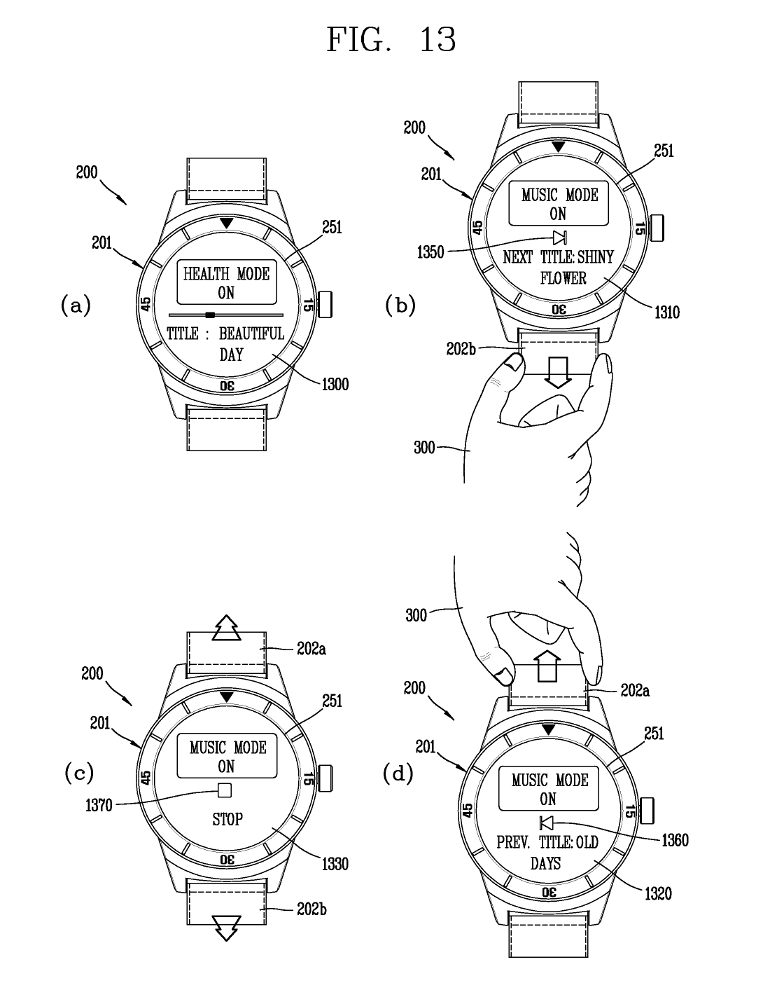

FIGS. 13 to 15 illustrate that during the performing of a specific function, when at least one band is pushed or pulled, and when a force in the horizontal or vertical direction is applied to the main body 201, the wearable device 100 according to an embodiment of the present invention is controlled accordingly. In the following description, it is assumed that the music playback function is performed in the wearable device 100 according to an embodiment of the present invention.

First, referring to FIG. 13, FIG. 13(a) shows an example in which the music playback function is executed in the wearable device 100 according to an embodiment of the present invention. In this case, the controller 180 may display the currently executing function, that is, a screen related to the music playback function (hereinafter referred to as a music playback screen: 1300) on the display unit 251. In this case, the music playback screen 1300 may include a title of a currently played song and information related to a state where the selected sound source is being played back.

In this state, the controller 180 may sense the input of the user pulling the first band 202a or the second band 202b. Then, in this case, the input of the user pulling the first band 202a or the second band 202b may correspond to a function of selecting a previous song of the currently playing song, or a function of selecting a next song.

For example, when an input of a user pulling the second band 202b is sensed, the controller 180 selects a song to be played back in the next order of the song currently being played back (hereinafter referred to as the ‘next song’), and allow the next selected song to be played back. Accordingly, when an input of a user pulling the second band 202b is sensed, as shown in FIG. 13(b), the controller 180 may display on the display unit 251 a screen 1310 including a title of the next song and a graphic object 1350 corresponding to the ‘selection of the next song’.

Meanwhile, the graphic object 1350 may be displayed while the input of the user is being applied. In other words, as shown in FIG. 13(b), when an input of a user pulling the second band 202b is sensed, the controller 180 may display the graphic object 1350 while the user is pulling the second band 202b. Or, it is apparent that the controller 180 may perform a plurality of operations according to the duration of the input of the user or the intensity of the input of the user. That is, for example, when the input of the user pulling the second band 202b exceeds a predetermined time or when the second band 202b is pulled with a preset intensity or more, the controller 180 may perform the process of selecting the ‘next music’ a plurality of times accordingly. As a result, it is possible to skip a plurality of songs.

On the other hand, when the input of the user pulling the first band 202a is sensed, the controller 180 may select the previous song of the song currently being played back. In this case, the controller 180 may allow a song (hereinafter referred to as a ‘previous song’) to be played back in the previous order of the song currently being played back. In this case, as shown in FIG. 13(c), the controller 180 may display, on the display unit 251, a screen 1320 including a title of a previous song and a graphic object 1360 corresponding to “selection of a previous song.” In addition, when the input of the user pulling the first band 202a exceeds a predetermined time or when the second band 202b is pulled with a preset intensity or more, the controller 180 may perform the process of selecting the “previous music” a plurality of times accordingly.

Moreover, the controller 180 may sense the input of the user simultaneously pulling the first band 202a and the second band 202b. In other words, as shown in FIG. 13(d), when the first band 202a and the second band 202b are simultaneously pulled, on the basis of this, the controller 180 may terminate music playback or terminate the function of performing music playback. Accordingly, when the first band 202a and the second band 202b are simultaneously pulled, as shown in FIG. 13(d), the controller 180 may display on the display unit 251 a graphic object 1370 corresponding to a state where music playback is stopped and a screen 1330 for displaying information related to a state where music playback is stopped.

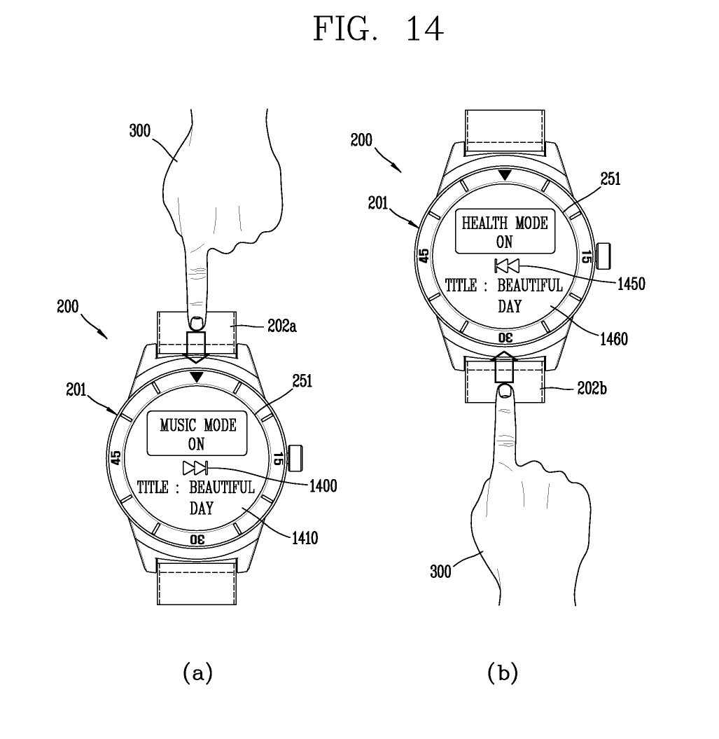

On the other hand, FIG. 14 shows an example in which in a state where a music playback function is executed, when the input of a user pushing at least one band is sensed, the wearable device 100 according to an embodiment of the present invention performs an operation corresponding thereto.

First, referring to FIG. 14(a), FIG. 14A illustrates an example in which an input of a user pushing the first band 202a is sensed while the music playback function is executed in the wearable device 100 according to an embodiment of the present invention. For example, when the function corresponding to the input of the user pushing the first band 202a is the “fast forward” function, the controller 180 may perform “fast forward” in response to the user's input, and as shown in FIG. 14(a), may display a screen 1410 including the graphic object 1400 corresponding to the fast forward function on the display unit 251.

Meanwhile, the controller 180 of the wearable device 100 according to an embodiment of the present invention may sense an input of a user pushing the second band 202b while executing the music playback function. In this case, the input of the user pushing the second band 202b may be a function contrary to the function corresponding to the input of the user pushing the first band 202a. For example, as shown in FIG. 14(a), when the function corresponding to the input of the user pushing the first band 202a is the “fast forward” function, the input of the user pushing the second band 202b may be a function of “rewind” in contrast to the “fast forward” function.

Accordingly, as shown in FIG. 14(b), when an input of a user pushing the second band 202b is sensed, the controller 180 may perform a rewind function and display a screen 1460 including a graphic object 1450 corresponding to the rewind function on the display unit 251.

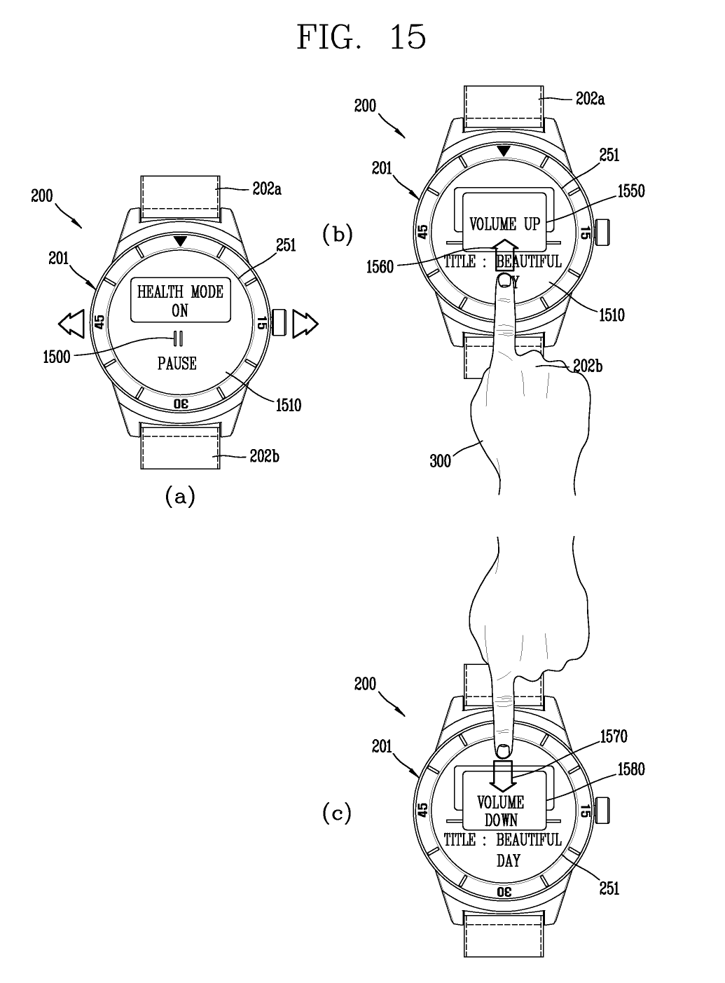

Moreover, FIG. 15 is an exemplary view showing an example in which the wearable device 100 according to an embodiment of the present invention performs a specific operation on the basis of the force applied to the main body while performing the music playback function.

Referring to FIG. 15(a), FIG. 15(a) shows an example in which the main body 201 is lifted by a user. In this case, as shown in FIG. 15(a), although a force similar to pulling the first band 202a and the second band 202b indirectly may be applied by lifting the main body 201, the controller 180 may sense that the main body 201 is lifted on the basis of the sensed acceleration according to the position movement of the main body 201 and/or the detection result of the touch sensor formed on the main body 201.

And, when the function corresponding to the lifting of the main body 201, that is, the force applied in the vertical direction, is the “pause” function, the controller 180 may pause the playback of the current music in response to the input of the user, and as shown in FIG. 15(a), may display a screen 1510 including the graphic object 1500 corresponding to the pause state on the display unit 251.

On the other hand, the controller 180 of the wearable device 100 according to an embodiment of the present invention may sense a force applied in a specific direction in a horizontal plane with respect to the display unit 251 provided on the main body, that is, the force in the horizontal direction, while running the music playback function. For example, when a force in the horizontal direction is sensed as described above, the controller 180 may sense the acceleration generated from the position movement of the main body 201 according to the force in the horizontal direction and may sense the magnitude and direction of the force applied to the main body 201 on the basis of the acceleration.

In other words, as shown in FIG. 15(b), when the user pushes the main body 201 in the first direction in which the first band 202a is coupled to the main body 201, the controller 180 may sense this as a user input. Then, in the case where the function corresponding to the user input when the force 1560 in the first direction is applied is the “volume increase” function, the controller 180 may increase the volume in response to the user's input, and as shown in FIG. 15(b), display the graphic object 1550 corresponding to the increase of the volume on the display unit 251.

On the other hand, when the user pushes the main body 201 in the second direction in which the second band 202b is coupled to the main body 201, the controller 180 may sense this as another user's input. In other words, as shown in FIG. 15(c), when a force 1570 pushing the main body 201 in the second direction is sensed, the controller 180 may reduce the volume corresponding thereto and display the graphic object 1580 corresponding to the reduction of the volume on the display unit 251.

In the above description, it is mentioned that the wearable device 100 according to an embodiment of the present invention determines the state of the current user and switches to the operation state where the function is performed on the basis of the vital signs sensed from the skin of the contacted user, i.e., heart rate, body temperature, etc.

Similarly, the wearable device 100 according to an embodiment of the present invention senses a surrounding situation and when there is another connectable device or vehicle, performs functions related to the vehicle on the basis of the force applied to at least one band or main body.

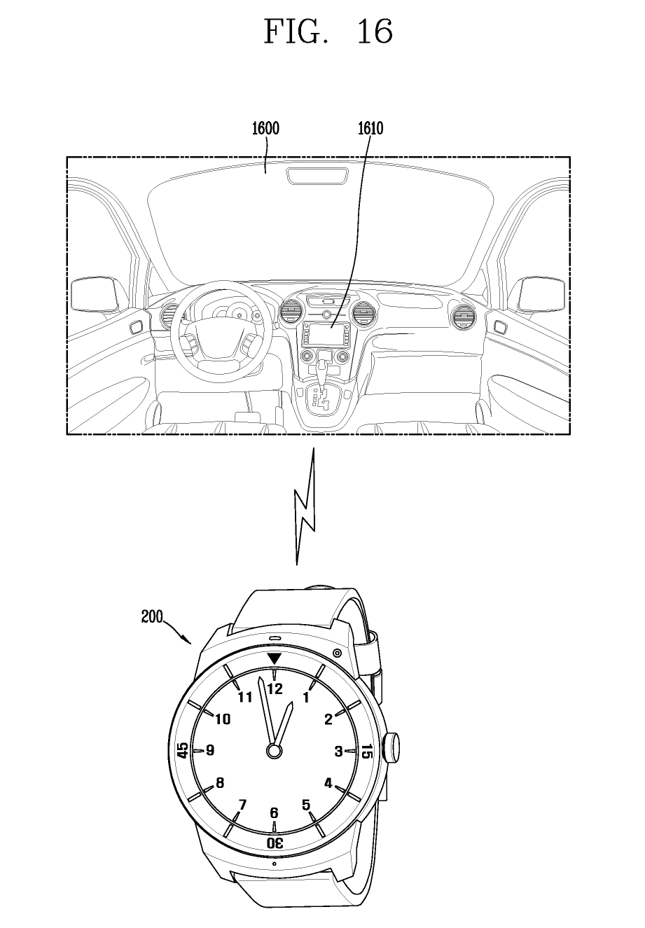

FIG. 16 is an exemplary view showing a state where the wearable device 100 according to an embodiment of the present invention is connected to a vehicle.

Referring to FIG. 16, the wearable device 200 may be connected to a vehicle control unit (not shown) in a wired or wireless manner to request a vehicle control unit to perform a specific function. A state where the vehicle is connected to the wearable device 200 and is interlocked with the wearable device 200 will be referred to as a “connected car” hereinafter.

In such a way, when in the “connected car” state, the wearable device 200 may transmit image information and/or sound information outputted from the wearable device 200 to an Audio/Video (NV) output device provided in the vehicle through a predetermined interface. And, the image information and/or the sound information transmitted to the output device of the vehicle may be outputted through the display unit 1610 and/or the audio system (not shown) provided in the vehicle. At this time, a means of an interface for transmission of image information and/or acoustic information may be a means for supporting wireless communication such as a wireless fidelity (WiFi) transceiver and a Bluetooth transceiver, or a means for supporting wired communication such as a Universal Serial Bus (USB) terminal.

On the other hand, in such a “connected car” state, the wearable device 200 may allow at least one of the executable functions in the vehicle to be executed. For example, the wearable device 200 may display image information outputted from the display unit 251 in a Head Up Display (HUD) manner through the display unit 1610 provided in the vehicle or a Wind Shield Glass 1600 of the vehicle. Alternatively, the user may open a window of the vehicle or may control the specific music data to be played back through the interface displayed on the display unit 251 of the wearable device 200. Alternatively, navigation information related to a predetermined point may be displayed on the display unit 1610 of the vehicle.

And, various functions related to the vehicle may be controlled on the basis of the users input to pull or push the bands 202a and 202b or the users input to lift or push the main body 201 in a particular direction. For example, when the bands 202a and 202b are simultaneously pulled or the main body 201 is lifted, the controller 180 may transmit a start signal to start the vehicle. Then, the vehicle may be switched to a mode in which the user is able to drive (drive mode).

In addition, the wearable device 100 according to an embodiment of the present invention may provide various functions related to the operation of the vehicle. For example, when the user is determined to be sleeping by sensing the user's heart rate or body temperature during drive, the controller 180 may decelerate the vehicle or output a warning sound. In this case, on the basis of the user's input to pull or push the bands 202a and 202b or the user's input to lift or push the main body 201 in a particular direction, the controller 180 may control the function of decelerating the vehicle or outputting a warning sound.

In the above description, while running a music playback function or a certain function such as a health mode, on the basis of the user's input to pull or push the bands 202a and 202b or the user's input to lift or push the main body 201 in a particular direction, the music playback function or the function of the health mode is to controlled. However, it is apparent that a different operation mode or another function may be performed or the function may be controlled.

For example, on the basis of an input of a user pulling the first band 202a or the second band 202b or an input of a user pushing the first band 202a or the second band 202b or an input of a user pushing the main body 201 in a first direction or a second direction, the controller 180 may adjust the brightness or volume of the screen or power on/off the display unit, or connect a call upon call reception, or terminate a connected call. Alternatively, when the camera function is being performed, the photograph may be taken, and a user's input may be used for capture a screen currently displayed on the display unit 251 while performing an internet surfing function.

In addition, each of these inputs may be independently applied to different functions. For example, the input of the user pushing the first band 202a or the second band 202b may correspond to the brightness control of the display unit 251. The input of the user pushing the main body 201 in the first or second direction may correspond to an increase or decrease in volume. The input of the user pulling the first band 202a or the second band 202b may correspond to connection or termination of a call.

Therefore, in this case, the user may connect the call by pulling the first band 202a and adjust the call volume by pushing the main body 201 in the first direction or the second direction during the call. Also, the brightness of the display unit 251 may be adjusted by pushing the first band 202a or the second band 202b during the call. And, the user may end the currently connected call by pulling the second band 202b.

In the above description, the force applied to the band or the main body 201 is sensed using an acceleration sensor or a pressure sensor, but the present invention is not limited thereto. That is, it is also possible to sense the pulling or to pushing of the band or the position movement of the main body 201 without using an acceleration sensor or a pressure sensor.

For example, the input of a user pulling or pushing the first band 202a or the second band 202b may be sensed by a heat sensing sensor formed on at least a portion of the first band 202a or the second band 202b. In this case, the heat sensing sensor senses the heat of the user's finger to sense movement of the user's finger, and on the basis of the sensed direction of movement of the user's finger, may sense the input of a user pulling or pushing the first band 202a or the second band 202b.

Alternatively, the input of a user pulling or pushing the first band 202a or the second band 202b may be sensed by using a plurality of proximity sensors provided in the first band 202a or the second band 202b. In this case, the controller 180 may sense the distance that the first band 202a or the second band 202b is spaced from the main body 201 from each proximity sensor, and sense the input of the user pulling or pushing the first band 202a or the second band 202b according to the change in the separation distance. In this case, a separate proximity sensor may be provided on the fastener 210 to which the first band 202a and the second band 202b are coupled, and the proximity sensor included in the fastener 210 may be used to sense the case where the first band 202a and the second band 202b are simultaneously pulled. That is, when the proximity sensors provided in the fastener 210 and the main body 201 are spaced apart from each other by more than a predetermined level, the controller 180 may determine that the first band 202a and the second band 202b are pulled simultaneously.

Also, the plurality of proximity sensors provided in the first band 202a and the second band 202b may be replaced by magnetic sensors. That is, when a magnetic sensor is used, the controller 180 may sense the distance that the first band 202a or the second band 202b is spaced from the main body 201 depending on the change in magnetic field sensed by each magnetic sensor, and sense the input of the user pulling or pushing the first band 202a or the second band 202b according to the change of the separation distance. In addition, a separate magnetic sensor may be provided on the fastener 210 to which the first band 202a and the second band 202b are coupled, and the magnetic sensor included in the fastener 210 may be used to sense the case where the first band 202a and the second band 202b are simultaneously pulled.

Meanwhile, the first band 202a and the second band 202b may be formed to be automatically wound including an auto rewinder. In this case, when the user pushes or pulls either the first band 202a or the second band 202b, the controller 180 may sense the rotation of the auto rewinder corresponding to the bands in either of the first band 202a and the second band 202b that are pushed or pulled by the user.

That is, for example, when a user pulls one of the bands, the auto rewinder corresponding to the band may be rotated in the direction in which the band is unwound. On the other hand, when a user pushes one of the bands, the auto rewinder corresponding to the band may be rotated in the direction in which the band is wound. Then, the controller 180 may sense the user's input to push or pull the first band 202a and/or the second band 202b on the basis of the rotation of the auto rewinder.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, the detailed description should not be limitedly construed in all of the aspects, and should be understood to be illustrative. Therefore, all changes and modifications that fall within the metes and bounds of the claims, or equivalents of such metes and bounds are therefore intended to be embraced by the appended claims.

1-20. (canceled)

21. A wearable device, comprising:
a body;
a band connected to the body and formed to be worn on a user's wrist; and
a controller located in the body and being configured to:
control a function executed at the wearable device in response to an applied force to the band.

22. The wearable device of claim 21, wherein the band includes a first band coupled to a first side of the body and a second band coupled to a second side of the body,
wherein the controller is further configured to:
control a separate function executed at the wearable device in response to each of:
pulling or pushing of any one of the first band or the second band,
pulling both the first band and the second band,
pushing the body in a first direction toward where the first band is coupled to the body,
pushing the body in a second direction toward where the second band is coupled to the body, and
lifting the body.

23. The wearable device of claim 22, further comprising:
a touch sensor coupled to the body at a location to contact the user, wherein the controller is further configured to:
identify the lifting of the body based on an input from the touch sensor indicating the lifting of the body.

24. The wearable device of claim 22, wherein the controller is further configured to:
identify the pulling of only the first band or the second band, or the pulling of both the first band and the second band, based on an intensity of force pulling the first band and an intensity of force pulling the second band.

25. The wearable device of claim 24, wherein the controller is further configured to:
identify the pulling of both the first band and the second band when an intensity difference of the force pulling the first band and the force pulling the second band is within a predetermined level; and
identify the pulling of only one of the first band or the second band when the intensity difference exceeds a predetermined level.

26. The wearable device of claim 24, further comprising:
a first pressure sensor coupled to the body at a location relative to where the first band is coupled to the body;
a second pressure sensor coupled to the body at a location relative to where the second band is coupled to the body, wherein the controller is further configured to:
measure the intensity of force pulling the first band based on input from the first pressure sensor; and
measure the intensity of force pulling the second band based on input from the second pressure sensor.

27. The wearable device of claim 22, wherein the controller is further configured to:
identify the lifting of the body when the body is lifted by a force applied to the body in a vertical direction.

28. The wearable device of claim 22, wherein the first band is removably coupled to the second band, wherein the controller is further configured to:
identify the pulling of both the first band and the second band at a same time when the first band is pulled in a first direction and the second band is pulled in a second direction opposite to the first direction.

29. The wearable device of claim 22, wherein the controller is further configured to:
identify the pulling or pushing of any one of the first band or the second band when the pulling or pushing exceeds a predetermined intensity or occurs for a time that exceeds a threshold.

30. The wearable device of claim 22, further comprising:
a speaker coupled to the body; and
a display coupled to the body, wherein the controller is further configured to:
variously adjust a brightness of the display or volume of the speaker according to one of the pulling or pushing of any one of the first band or the second band, the pushing the body in the first direction, or the pushing the body in a second direction.

31. The wearable device of claim 22, wherein the controller is further configured to:
connect an incoming call or end a connected call according to one of the pulling or pushing of any one of the first band or the second band, the pushing the body in the first direction, or the pushing the body in a second direction.

32. The wearable device of claim 22, wherein the controller is further configured to:
switch an operation mode of the wearable device to a specific operation mode in response to an input, wherein the input includes the pulling or pushing of any one of the first band or the second band, and the pushing the body in the first direction or the second direction,
wherein the specific operation mode is an operation mode for performing functions corresponding to a sensed body state of the user.

33. The wearable device of claim 32, wherein the specific operation mode includes a plurality of functions separately associated with the pulling of the first band, the pulling of the second band, the pushing of the first band, the pushing of the second band, the pushing of the body in the first direction, and the pushing of the body in the second direction,
wherein the controller is further configured to:
execute a function of the plurality of functions of the specific operation mode based on a type of the input.

34. The wearable device of claim 32, further comprising:
a display coupled to the body, wherein the controller is further configured to:
cause the display to display information corresponding to the executed function, wherein the information includes a graphic function.

35. The wearable device of claim 34, wherein the controller is further configured to:
cause the display to display the information while the input is being received; and
cause the display to terminate the displaying of the information when the input is no longer received.

36. The wearable device of claim 34, wherein the controller is further configured to:
execute again the function of the plurality of functions of the specific operation mode according to a time that the input is received.

37. The wearable device of claim 21, wherein the function includes switching an operation mode of the wearable device to a specific operation mode,
wherein the specific operation mode is an operation mode corresponding to a peripheral device which is wirelessly connectable to the wearable device.

38. The wearable device of claim 37, wherein the peripheral device is located at a vehicle within which the user wearing the wearable device is located, and the specific operation mode is an operation mode for performing functions relating to control of the vehicle.

39. The wearable device of claim 21, wherein the applied force is pulling or pushing.

40. A method for controlling a wearable device including a plurality of bands formed to be worn on a user's wrist, the method comprising:
switching an operation mode of the wearable device to a specific operation mode in response to an input of a sensed state of the user or a situation proximate to the wearable device;
identifying an input comprising any of pulling or pushing of any of the plurality of bands, or pushing the body in a specific direction; and
controlling a function executable at the wearable device in response to the identified input.
